(19) United States
(12) Patent Application Publication
(10) Pub. No.: US 2026/0027695 A1
(43) Pub. Date: Jan. 29, 2026

(54) Tool Housing with Adjustable Center of Gravity

(71) Applicant: Hubbell Incorporated, Shelton, CT (US)

(72) Inventor: Robert D. Auger, Merrimack, NH (US)

(21) Appl. No.: 19/259,469

(22) Filed: Jul. 3, 2025

Related U.S. Application Data
(60) Provisional application No. 63/675,326, filed on Jul. 25, 2024.

(51) Int. Cl. B25F 5/02; B25F 5/00; H01R 43/042

(52) U.S. Cl. CPC B25F 5/02; B25F 5/005; H01R 43/0427; H01R 43/0428

(57) ABSTRACT

A hydraulic power tool with adjustable center of gravity, the hydraulic power tool includes a handle assembly having a frame, the handle assembly capable of being operatively coupled to one of a plurality of differently configured working head assemblies and a power unit housed by the frame. The power unit is longitudinally movable and positionable within the frame depending on which of the plurality of differently configured working head assemblies is operatively coupled to the handle assembly to maintain a substantially constant center of gravity of the hydraulic power tool regardless of which of the plurality of differently configured working head assemblies is operatively coupled to the handle assembly.

### CROSS-REFERENCE TO RELATED APPLICATIONS

This application claims priority to U.S. Provisional Application Ser. No. 63/675,326 filed Jul. 25, 2024 entitled TOOL HOUSING WITH ADJUSTABLE CENTER OF GRAVITY the contents of which are incorporated herein in their entirety by reference.

### TECHNICAL FIELD

The present disclosure relates generally to tool housings and, more particularly, to tool housings with adjustable center of gravity.

### DESCRIPTION OF THE RELATED ART

Hand-held tools including, for example, hand-held hydraulic tools are well known in the art. Such tools typically use a working head which may include cooperating jaws or movable dies that are hydraulically pressed together with great force to crimp electrical connections or cut materials such as electrical conductors. These tools may be battery-powered to allow mobility and portability for the user. To save costs, these tools may be modular in nature and may be capable of utilizing different working heads for performing different tasks. For example, these tools may include a power module and a housing including a handle of some type. Various working heads may be interchangeably attached to the tool, each specifically designed to accomplish a specific task. For example, the working heads may be designed to cut cables of a specific size or size range and/or crimp specific sized crimps or crimps of a specific size range.

One disadvantage of such module type tools is that the interchangeable working heads may generally be different sizes and/or weights. Accordingly, when various working heads are attached to the tool, the center of gravity of the tool will inevitably change. Ideally, the center of gravity of a hand tool will be in the vicinity of the handle. A tool with a center of gravity placed other than in the vicinity of the handle can be awkward to use and can cause great discomfort and fatigue for the user, particularly when the tool is being held and used for any length of time.

A need exists for a hand-held tool having a movable center of gravity that can be adjusted to compensate for various interchangeable working heads that can be attached to the tool.

### SUMMARY OF THE INVENTION

The present disclosure relates generally to hydraulic power tools, and more particularly to hydraulic power tools with adjustable center of gravity. The hydraulic power tool includes a handle assembly having a frame, the handle assembly capable of being operatively coupled to one of a plurality of differently configured working head assemblies and a power unit housed by the frame. The power unit is longitudinally movable and positionable within the frame depending on which of the plurality of differently configured working head assemblies is operatively coupled to the handle assembly to maintain a substantially constant center of gravity of the hydraulic power tool regardless of which of the plurality of differently configured working head assemblies is operatively coupled to the handle

In an exemplary embodiment, the power tool is a hand-held power tool with adjustable center of gravity, the power tool including a handle assembly capable of being operatively coupled to one of a plurality of differently configured working head assemblies and a power unit housed by the handle assembly. The power unit is movable and positionable within the handle assembly depending on which of the plurality of differently configured working head assemblies is operatively coupled to the handle assembly to maintain a substantially constant center of gravity of the hydraulic power tool regardless of which of the plurality of differently configured working head assemblies is operatively coupled to the handle assembly.

### BRIEF DESCRIPTION OF THE DRAWINGS

The figures depict embodiments for purposes of illustration only. It will readily appreciated from the following description that alternative embodiments of the structures illustrated herein may be employed without departing from the principles described herein, wherein:

FIG. 1A is a side view of a portable hand-held power tool including a first working head assembly according to an exemplary embodiment of the present disclosure;

FIG. 1B is a side view of a portable hand-held power tool including a second working head differently configured than the first working head according to an exemplary embodiment of the present disclosure;

FIG. 2A is a side view of components forming portions of a portable hand-held power tool according to an exemplary embodiment of the present disclosure;

FIG. 2B is a side sectional view of a first side of a portable hand-held power tool including a modular power unit according to an illustrative embodiment of the present disclosure;

FIG. 3 is a perspective view of a portable hand-held power tool having a working head assembly, according to an illustrative embodiment of the present disclosure;

FIG. 4 is a perspective view of the portable hand-held power depicted in FIG. 3 with end cap removed showing a portion of the modular power unit according to an illustrative embodiment of the present disclosure;

FIG. 5 is a cross-sectional view of the portable hand-held power tool of FIG. 3 taken along lines 5-5 of FIG. 3 according to an illustrative embodiment of the present disclosure;

FIG. 6 is an enlarged sectional view of a portion of the portable hand-held power tool of FIG. 5, i.e. detail 6 according to an illustrative embodiment of the present disclosure;

FIG. 7 is a perspective view of a portable hand-held power tool having a differently configured working head, according to an illustrative embodiment of the present disclosure;

FIG. 8 is a perspective view of the portable hand-held power depicted in FIG. 7 with end cap removed according to an illustrative embodiment of the present disclosure;

FIG. 9 is a cross-sectional view of the portable hand-held power tool of FIG. 7 taken along lines 9-9 of FIG. 7 according to an illustrative embodiment of the present disclosure;

FIG. 10 is an enlarged sectional view of a portion of the portable hand-held power tool detail 10 of FIG. 9 according to an illustrative embodiment of the present disclosure;

FIG. 11 is a perspective view of a hand-held power tool according to another illustrative embodiment of the present disclosure;

FIG. 12 is a perspective view of the portable hand-held power depicted in FIG. 11 with end cap removed according to an illustrative embodiment of the present disclosure;

FIG. 13 is a cross-sectional view of a portion of the portable hand-held power tool of FIG. 11 taken along lines 13-13 of FIG. 11 according to an illustrative embodiment of the present disclosure;

FIGS. 14-16 are perspective views of replaceable fluid reservoirs according to illustrative embodiments of the present disclosure;

FIG. 17 is an exploded perspective view of a hand-held power tool according to an illustrative embodiment of the present disclosure;

FIG. 18 is a cross-sectional view of the portable hand-held power tool of FIG. 11 taken along lines 18-18 of FIG. 11 according to an illustrative embodiment of the present disclosure;

FIG. 19 is an enlarged cross-sectional view of a portion of the hand-held power tool detail 19 of FIG. 18 according to an illustrative embodiment of the present disclosure;

FIG. 20 is a perspective view of the hand-held power tool having a differently configured working head assembly according to an illustrative embodiment of the present disclosure;

FIG. 21 is a perspective view of the hand-held power tool of FIG. 20 with end cap removed according to an illustrative embodiment of the present disclosure;

FIG. 22 is a perspective view of a hand-held power tool according to another illustrative embodiment of the present disclosure;

FIG. 23 is a perspective view of the hand-held power tool of FIG. 22 with end cap removed according to an illustrative embodiment of the present disclosure;

FIG. 24 is a cross-sectional view of the hand-held power tool of FIG. 22 taken along lines 24-24 according to an illustrative embodiment of the present disclosure;

FIG. 25 is an enlarged cross-sectional view of a portion of the hand-held power tool detail 25 of FIG. 24 according to an illustrative embodiment of the present disclosure;

FIG. 26 is a perspective view of a hand-held power tool having a differently configured working head assembly according to an illustrative embodiment of the present disclosure;

FIG. 27 is a side perspective view of a modular power unit according to illustrative embodiments of the present disclosure;

FIG. 28 is an exploded perspective view of the modular power unit of FIG. 27, illustrating a pump assembly, a transmission assembly and a motor according to illustrative embodiments of the present disclosure;

FIG. 29 is a side elevation view of the transmission assembly of FIG. 28 according to an illustrative embodiment of the present disclosure;

FIGS. 30 and 31 are first side elevation views of the modular power unit of FIG. 27, illustrating the pump assembly, the transmission assembly and the motor according to illustrative embodiments of the present disclosure;

FIGS. 32 and 33 are second side elevation views of the modular power unit of FIG. 27 rotated approximately 90 degrees from the orientation of the modular power unit of FIGS. 30 and 31 according to illustrative embodiments of the present disclosure;

FIGS. 34 and 35 are third side elevation views of the modular power unit of FIG. 27 rotated approximately 90 degrees from the orientation of the modular power unit of FIGS. 32 and 33 according to illustrative embodiments of the present disclosure;

FIGS. 36 and 37 are a fourth side elevation view of the modular power unit of FIG. 27 rotated approximately 90 degrees from the orientation of the modular power unit of FIGS. 34 and 35 according to illustrative embodiments of the present disclosure;

FIG. 36A is an end elevation view of the modular power unit of FIG. 36 taken from line 36A-36A of FIG. 36 according to illustrative embodiments of the present disclosure;

FIG. 36B is an end elevation view of the modular power unit of FIG. 36 taken from line 36B-36B of FIG. 36 according to illustrative embodiments of the present disclosure;

FIG. 37A is an end elevation view of the modular power unit of FIG. 37 taken from line 37A-37A of FIG. 37 according to illustrative embodiments of the present disclosure;

FIG. 37B is an end elevation view of the modular power unit of FIG. 37 taken from line 37B-37B of FIG. 37 according to illustrative embodiments of the present disclosure;

FIG. 38 is a cross-sectional view of the modular power unit of FIG. 34 taken from line 38-38 of FIG. 34 according to illustrative embodiments of the present disclosure;

FIG. 39 is a perspective view from a first end of the transmission assembly according to an exemplary embodiment of the present disclosure;

FIG. 40 is a perspective view from a second end of the transmission assembly of FIG. 39 according to an illustrative embodiment of the present disclosure;

FIG. 41 is a cross-sectional view of the transmission assembly of FIG. 39 taken from line 41-41 of FIG. 39 and illustrating a gear assembly, a wobble plate drive member and a wobble plate according to an illustrative embodiment of the present disclosure;

FIG. 41A is a cross-sectional view of the transmission assembly of FIG. 39 similar to FIG. 41, illustrating the wobble plate in a retracted position that coincides with an intake stroke of a pump in the pump assembly according to an illustrative embodiment of the present disclosure;

FIG. 41B is a cross-sectional view of the transmission assembly of FIG. 39 similar to FIG. 41, illustrating the wobble plate in an extended position that coincides with an exhaust stroke of the pump in the pump assembly according to an illustrative embodiment of the present disclosure;

FIG. 42 is a side perspective view of an exemplary embodiment of the wobble plate of the transmission assembly of FIG. 41;

FIG. 43 is a side perspective view of the wobble plate drive member of FIG. 41 according to an illustrative embodiment of the present disclosure;

FIG. 44 is a side elevation view of the wobble plate drive member of FIG. 43 according to an illustrative embodiment of the present disclosure;

FIG. 45 is a schematic representation of the pump assembly according to according to an illustrative embodiment of the present disclosure;

FIG. 46 is a perspective view of an exemplary embodiment of the pump assembly according to the present disclosure, illustrating an electrical cable used to connect a sensor of the pump assembly to a controller within the handle assembly;

FIG. 47 is a side elevation view of the pump assembly of FIG. 46 without the electrical cable, illustrating the sensor extending from a housing of the pump assembly according to an illustrative embodiment of the present disclosure;

FIG. 48 is a second side elevation view of the pump assembly of FIG. 47 rotated approximately 90 degrees from the orientation of the pump assembly of FIG. 47 according to an illustrative embodiment of the present disclosure;

FIG. 49 is another side elevation view of the pump assembly of FIG. 48 rotated approximately 90 degrees from the orientation of the pump assembly of FIG. 48 according to an illustrative embodiment of the present disclosure;

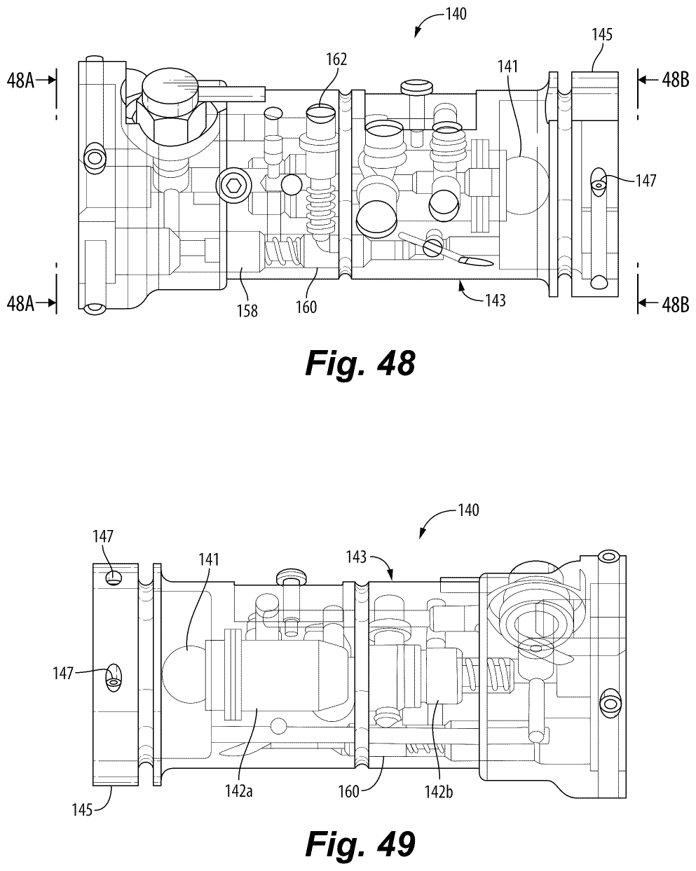

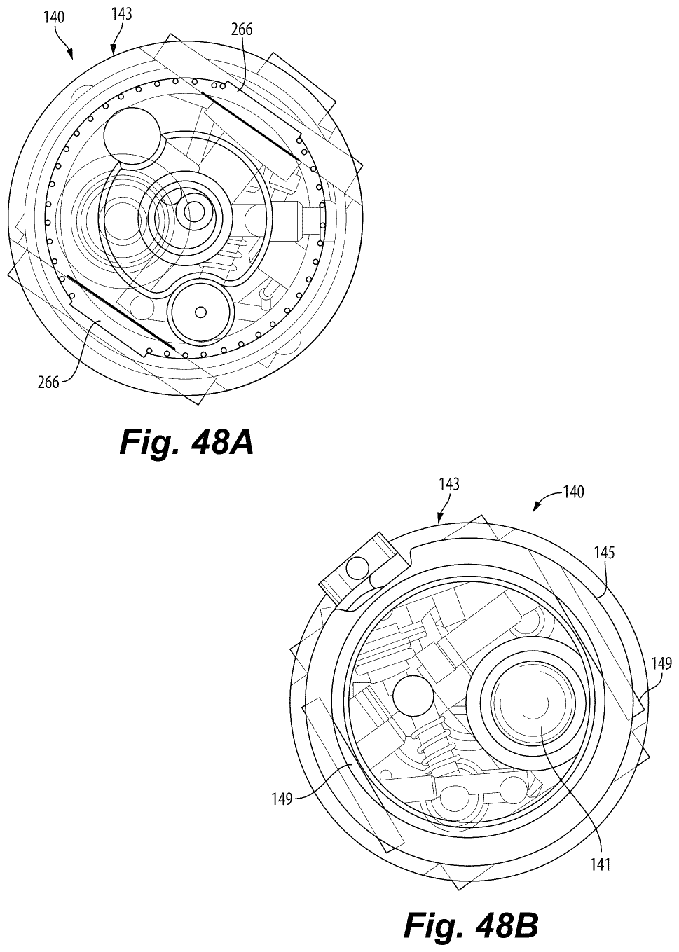

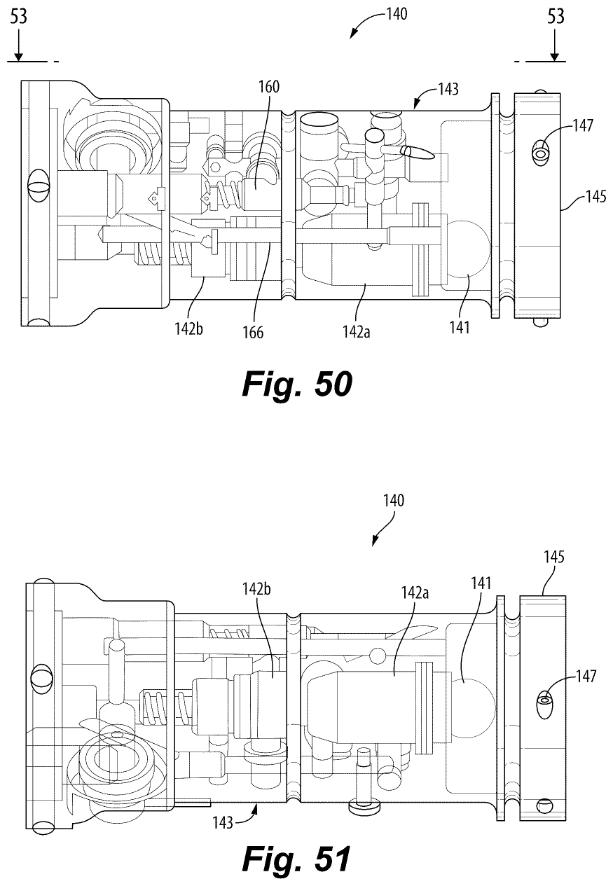

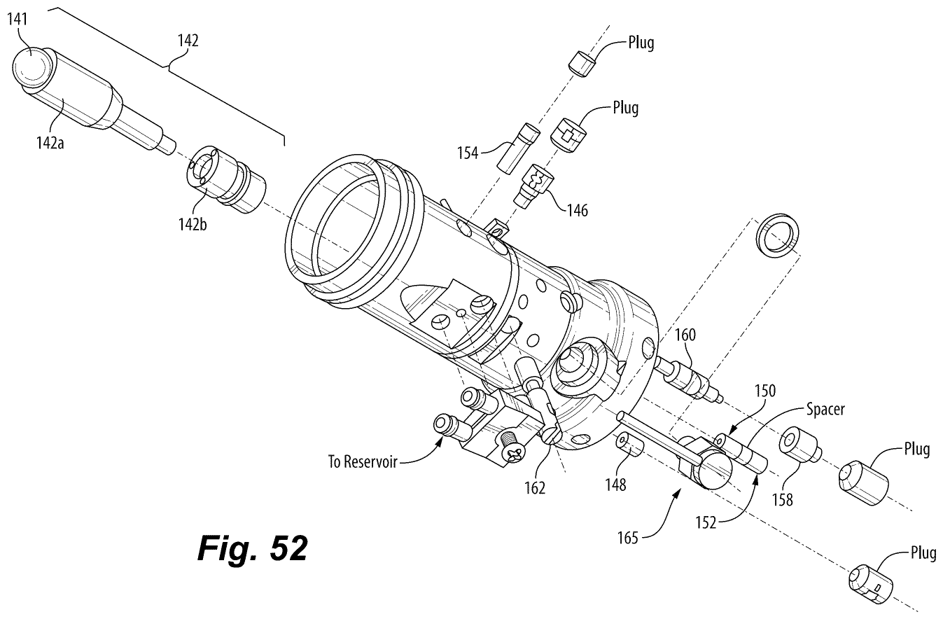

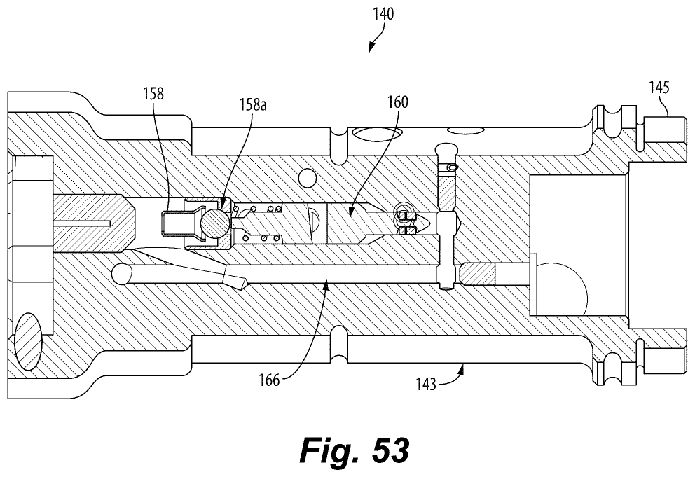

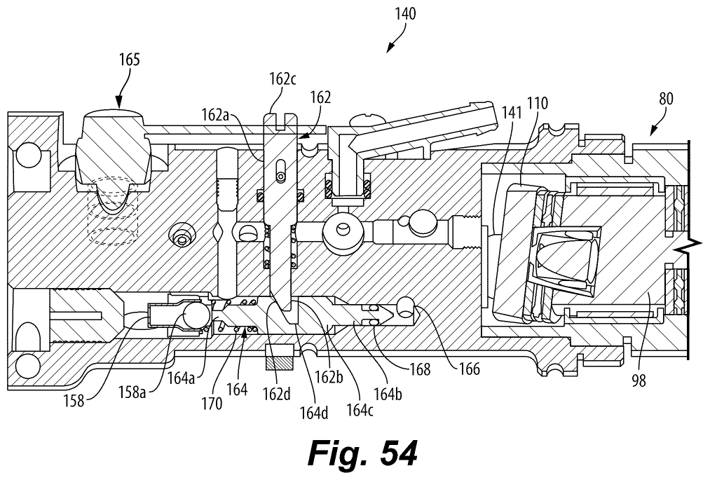

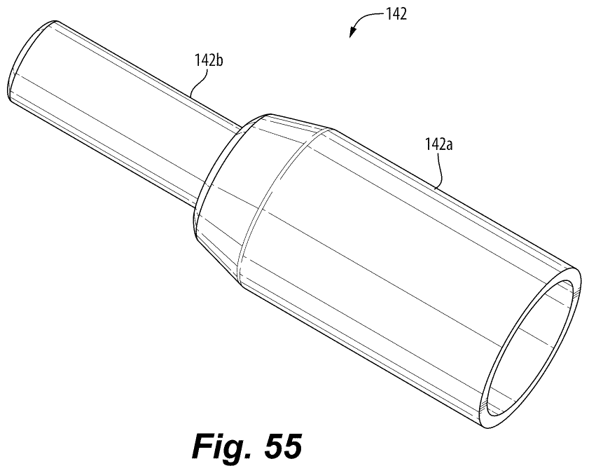

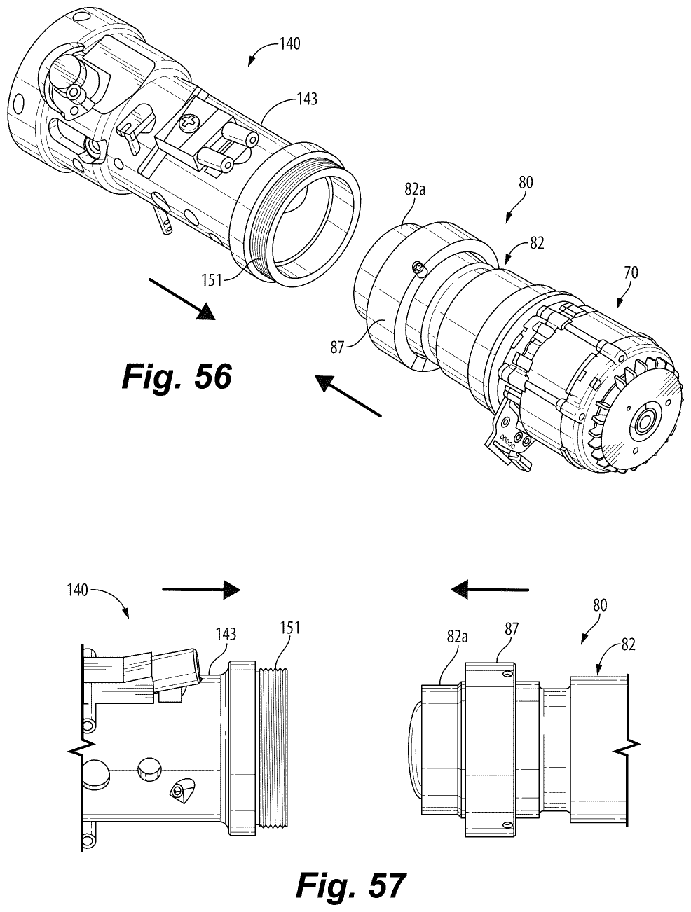

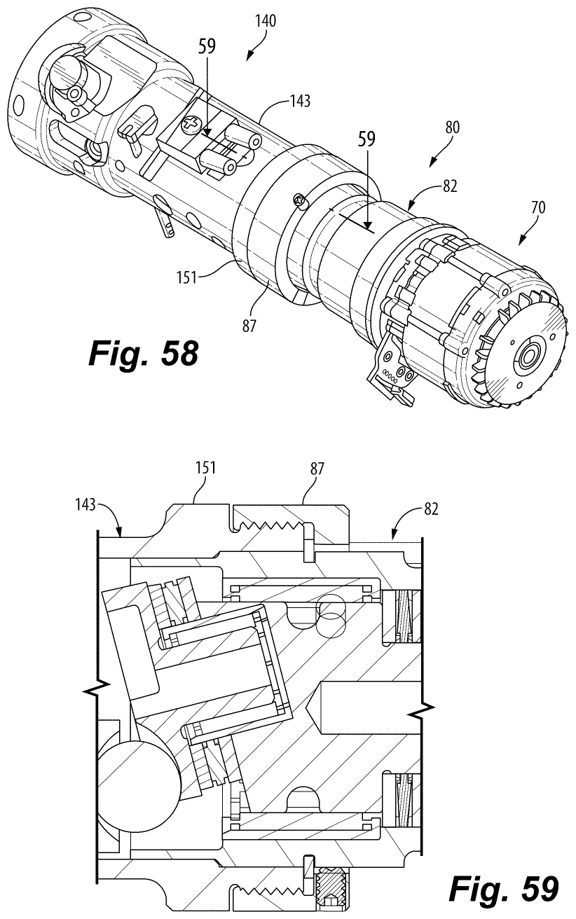

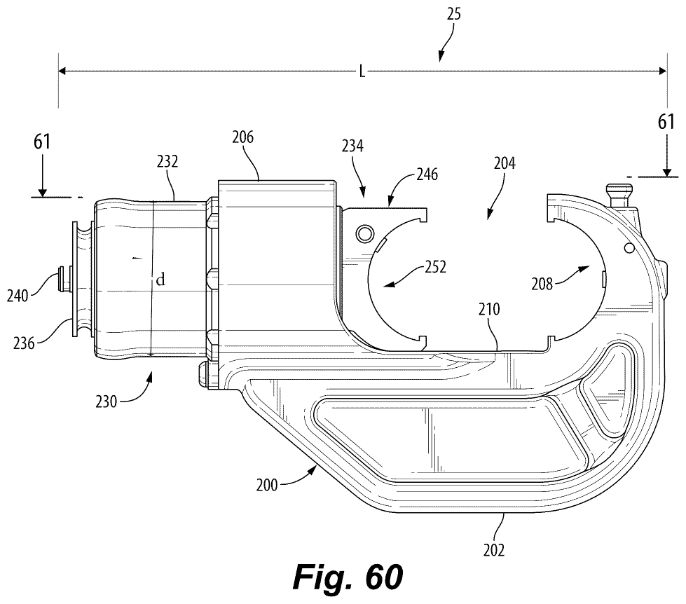

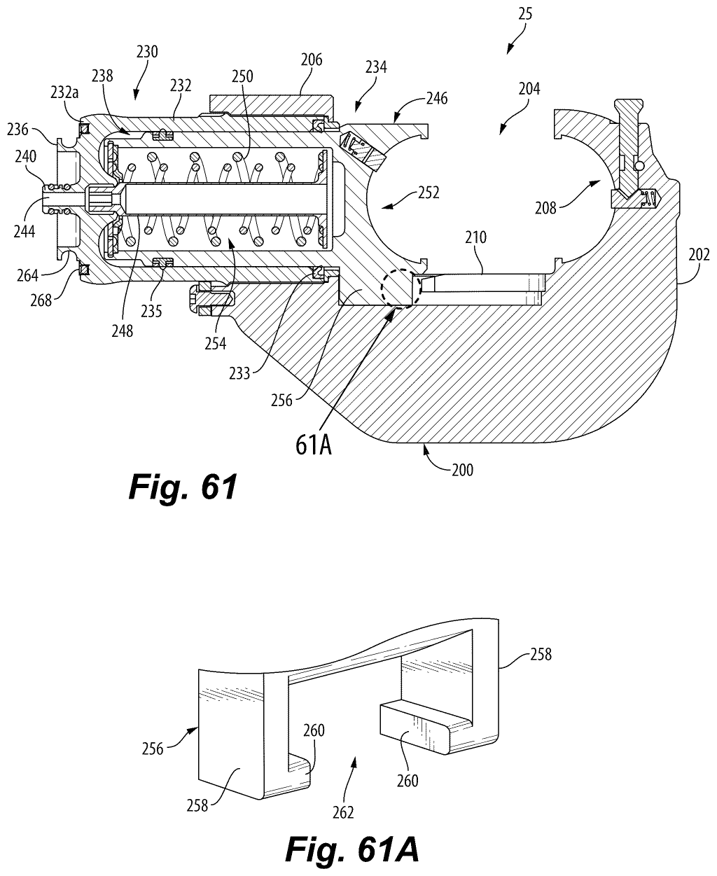

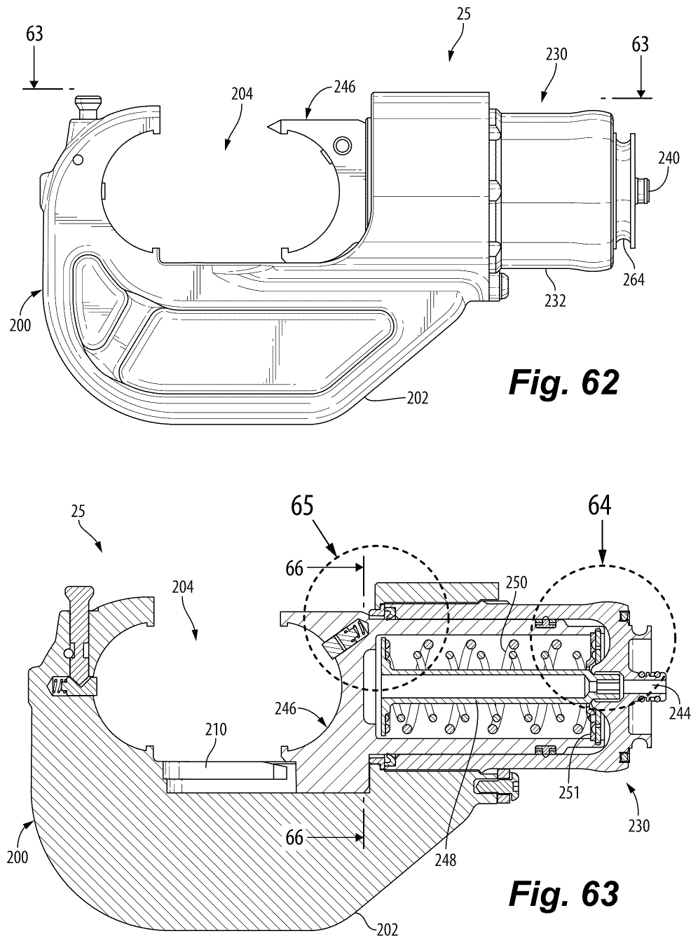

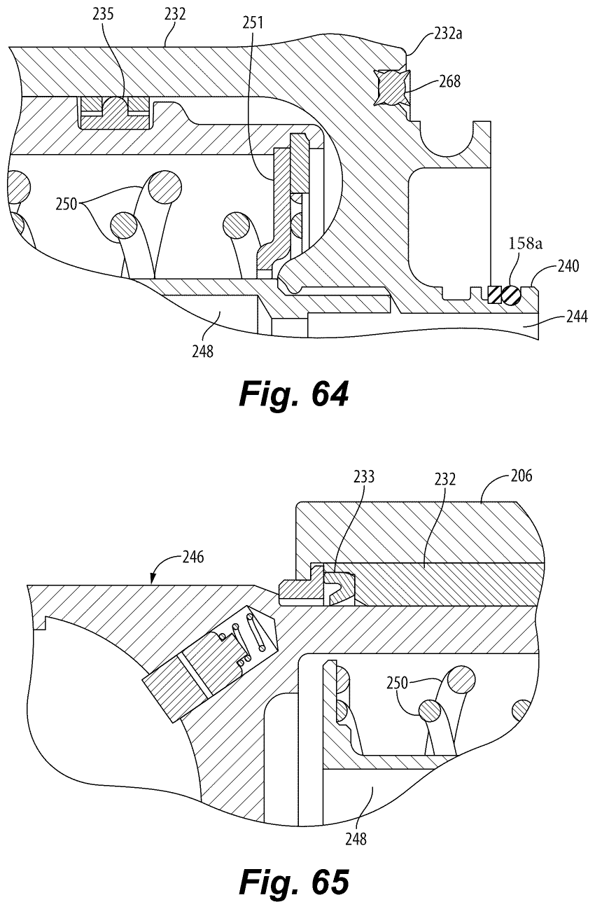

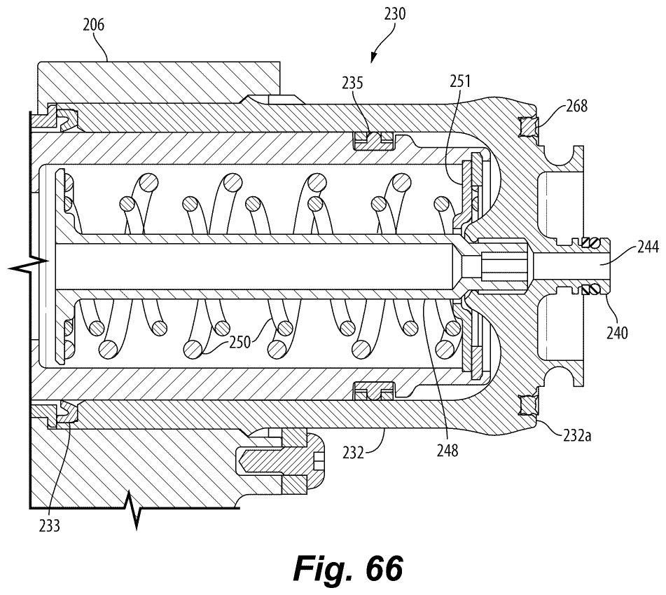

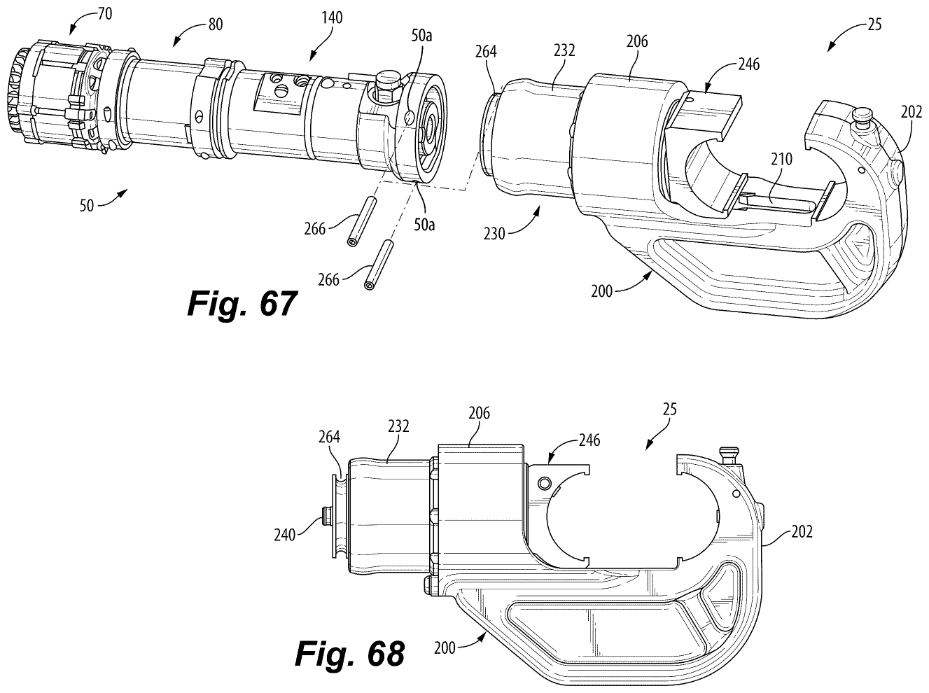

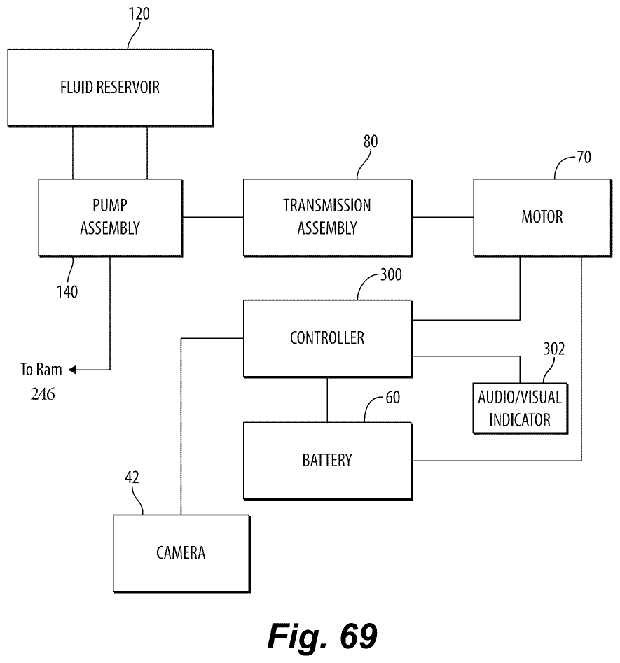

FIG. 48A is an end elevation view of the modular power unit of FIG. 48 taken from line 48A-48A of FIG. 48 according to an illustrative embodiment of the present disclosure;

FIG. 48B is an end elevation view of the modular power unit of FIG. 48 taken from line 48B-48B of FIG. 48 according to an illustrative embodiment of the present disclosure;

FIG. 50 is a side elevation view of the pump assembly of FIG. 49 rotated about an axis transverse to a longitudinal axis of the pump assembly according to an illustrative embodiment of the present disclosure;

FIG. 51 is a third side elevation view of the pump assembly of FIG. 47 rotated approximately 90 degrees from the orientation of the pump assembly of FIG. 47 according to an illustrative embodiment of the present disclosure;

FIG. 52 is an exploded perspective view of the pump assembly of FIG. 47 according to an illustrative embodiment of the present disclosure;

FIG. 53 is a cross-sectional view of the pump assembly of FIG. 50 taken from line 53-53 of FIG. 50, illustrating a pressure balance system of the pump assembly according to an illustrative embodiment of the present disclosure;

FIG. 54 is a cross-sectional view of the pump assembly of FIG. 50 taken from line 53-53 of FIG. 50, illustrating the pressure balance valve of the pump assembly according to an illustrative embodiment of the present disclosure;

FIG. 55 is a perspective view of an exemplary embodiment of a two stage pump of the pump assembly according to an illustrative embodiment of the present disclosure;

FIG. 56 is an exploded perspective view of another exemplary embodiment of the modular power unit, illustrating a male threaded end of the pump assembly configured to connect to a female threaded collar of the transmission assembly according to an illustrative embodiment of the present disclosure;

FIG. 57 is a side elevation view of a portion of the male threaded end of the pump assembly configured to connect to the female threaded collar of the transmission assembly according to an illustrative embodiment of the present disclosure;

FIG. 58 is a perspective view of the modular power unit of FIG. 56, illustrating the male threaded end of the pump assembly connected to the female threaded collar of the transmission assembly according to an illustrative embodiment of the present disclosure;

FIG. 59 is a cross-sectional view of the modular power unit of FIG. 58 taken from line 59-59 of FIG. 58, illustrating the male threaded end of the pump assembly connected to the female threaded collar of the transmission assembly according to an illustrative embodiment of the present disclosure;

FIG. 60 is a first side elevation view of an exemplary embodiment of the modular working head assembly of the portable, hand-held hydraulic tool according to an illustrative embodiment of the present disclosure;

FIG. 61 is a cross-sectional view of the modular working head assembly of FIG. 60 taken from line 61-61 of FIG. 60 and illustrating a piston assembly of the modular working head assembly according to an illustrative embodiment of the present disclosure;

FIG. 61A is an enlarged view of a portion of a T-shaped guide of the piston assembly of FIG. 61 taken from detail 61A of FIG. 61 according to an illustrative embodiment of the present disclosure;

FIG. 62 is a second side elevation view of the modular working head assembly of the portable, hand-held hydraulic tool according to an illustrative embodiment of the present disclosure;

FIG. 63 is a cross-sectional view of the modular working head assembly of FIG. 62 taken from line 63-63 of FIG. 62 and illustrating a piston assembly of the modular working head assembly according to an illustrative embodiment of the present disclosure;

FIG. 64 is an enlarged view of a portion of the piston assembly of FIG. 63 taken from detail 64 of FIG. 63;

FIG. 65 is an enlarged view of a portion of the piston assembly of FIG. 63 taken from detail 65 of FIG. 63;

FIG. 66 is an is an enlarged view of a portion of the piston assembly of FIG. 63 taken from line 66-66 of FIG. 63;

FIG. 67 is a perspective view of the modular power unit positioned for coupling to the modular working head assembly according to an illustrative embodiment of the present disclosure;

FIG. 68 is a side elevation view of the working head of FIG. 67, illustrating a rotational groove of the piston assembly of the modular working head assembly configured to mate with a corresponding rotational groove in a collar of the pump assembly according to an illustrative embodiment of the present disclosure; and

FIG. 69 is an exemplary block diagram for describing various parts of the tool shown according to illustrative embodiments of the present disclosure.

### DETAILED DESCRIPTION

The present disclosure will be shown and described in connection with portable, hand-held, hydraulic tools that utilize a modular power unit to move one or more jaws or one or more dies in a working head assembly of the tools. For ease of description, the portable, hand-held hydraulic tools according to the present disclosure may also be referred to as the “tools” in the plural and the “tool” in the singular. In addition, as used in the present disclosure, the terms “front,” “rear,” “upper,” “lower,” “upwardly,” “downwardly,” and other orientation descriptors are intended to facilitate the description of the exemplary embodiments disclosed herein and are not intended to limit the structure of the exemplary embodiments or limit the claims to any particular position or orientation.

The tools are adapted to be battery-powered and can generate forces of at least 6 tons when acting on a workpiece positioned in a working area of the working head assembly. Non-limiting examples of the tools contemplated by the present disclosure include crimping tools and cutting tools. With some crimping tools, a pair of dies may be used to make a crimp, where one die is typically fixed and the other die is movable. With other crimping tools, an indentor may be movable relative to a fixed nest to make a crimp. With cutting tools, one or more movable jaws with cutting blades can be used to cut a workpiece. However, the present disclosure contemplates that the inventive concepts and aspects of the tools may be implemented in a wide variety of tools, fields and uses. Therefore, the present disclosure should not be deemed to be limited to the embodiments of portable, hand-held, hydraulic crimping or cutting tools shown in the drawings and described herein.

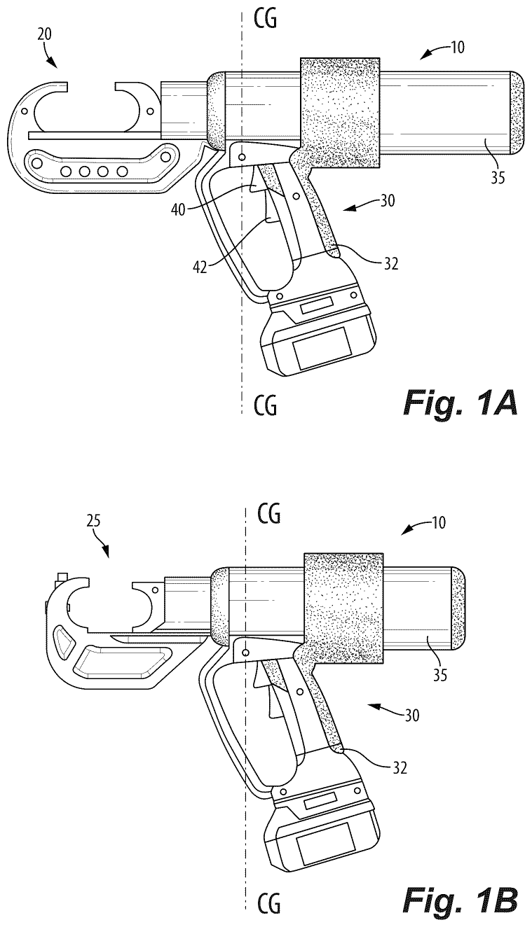

A tool 10 according to an illustrative embodiment of the present disclosure is depicted in FIGS. 1-10. Tool 10 includes a handle assembly 30 that may have various modular working head assemblies attached thereto, each working head assembly for performing a different task. For example, as depicted in FIG. 1A, a first modular working head assembly 20 for crimping connectors of a first size or size range is operatively connected to tool 10. As depicted in FIG. 1B, the first modular working head assembly 20 has been removed from tool 10 and replaced with a second modular working head assembly 25 for crimping connectors of a second size or size range.

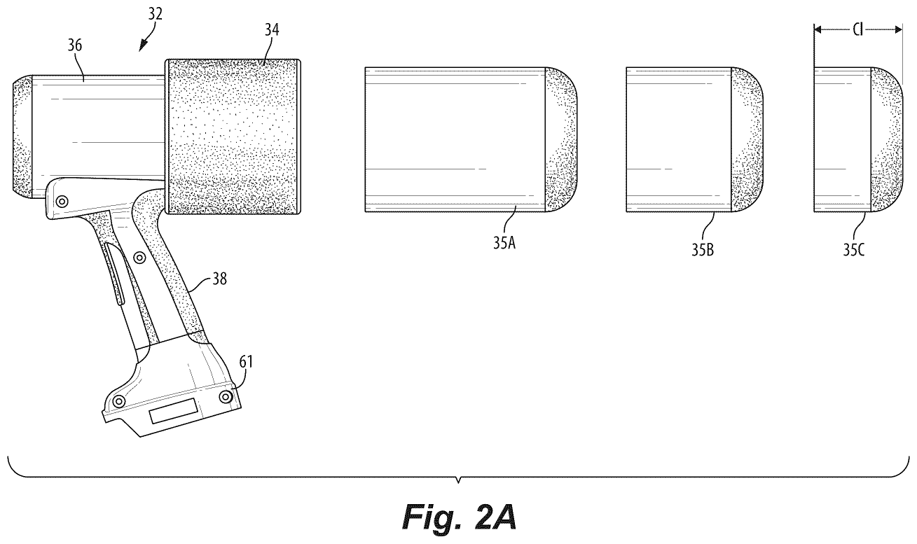

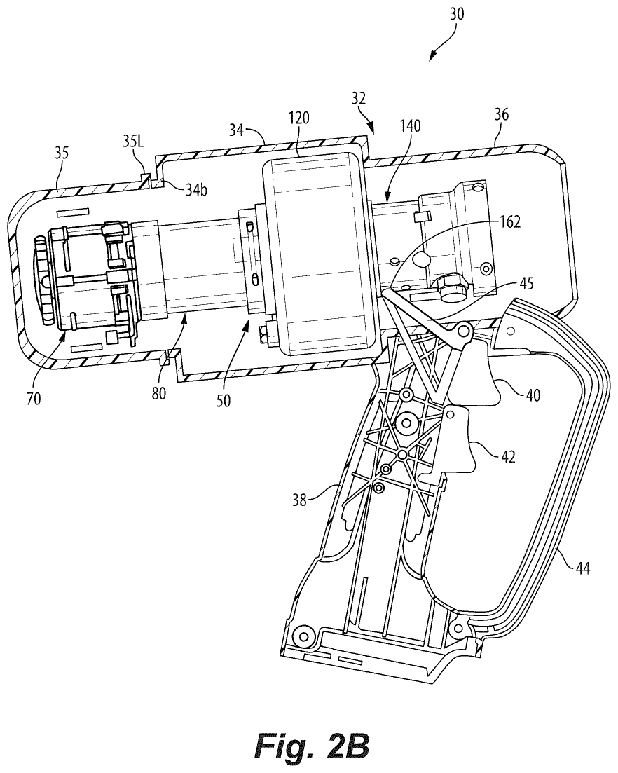

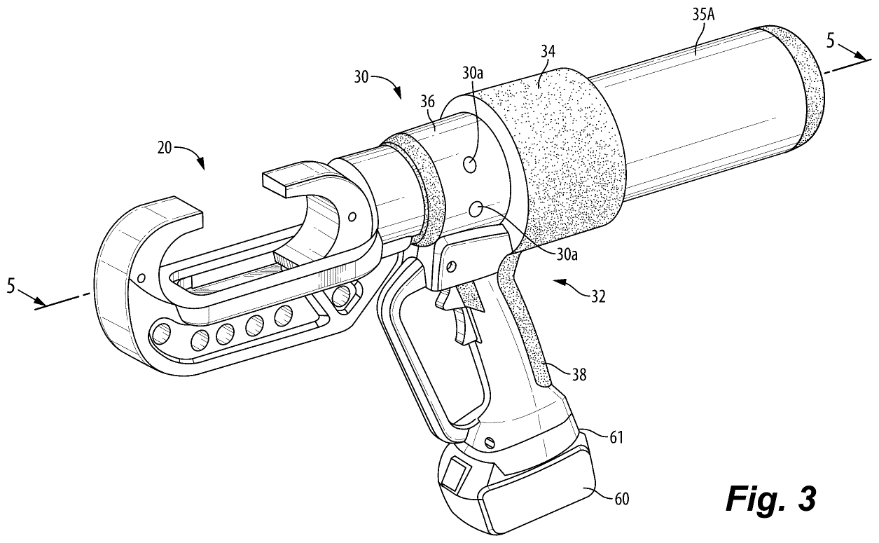

Handle assembly 30 may have various configurations. According to an illustrative embodiment of the present disclosure as depicted in FIG. 2A, 2B, handle assembly 30 includes a pistol type tool frame 32, allowing the user to hold and operate tool 10 with one hand. A replaceable cup or cap 35 covers a portion of the inner workings of the tool 10. Referring to FIG. 2A, pistol type tool frame 32 has a main body portion 34, a neck portion 36 and a hand grip portion 38. The handle assembly 30 houses a modular power unit 50 depicted in FIG. 2B. Handle assembly 30 also houses a controller 300 (FIG. 69) that provides electrical controls for the tool, an attachment port 61 for receiving a replaceable battery 60 (FIG. 3) and other components of the tool 10. The pistol type tool frame 32 may be a two-part housing that when joined together form one or more cavities or compartments configured to receive the modular power unit 50 (FIG. 2B), the controller (FIG. 69), battery attachment port 61 and the other components of the tool 10.

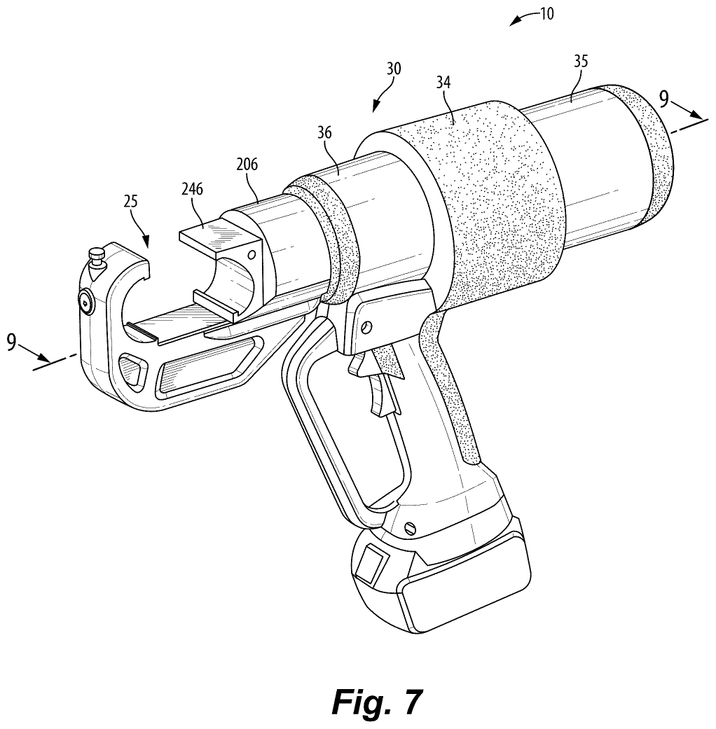

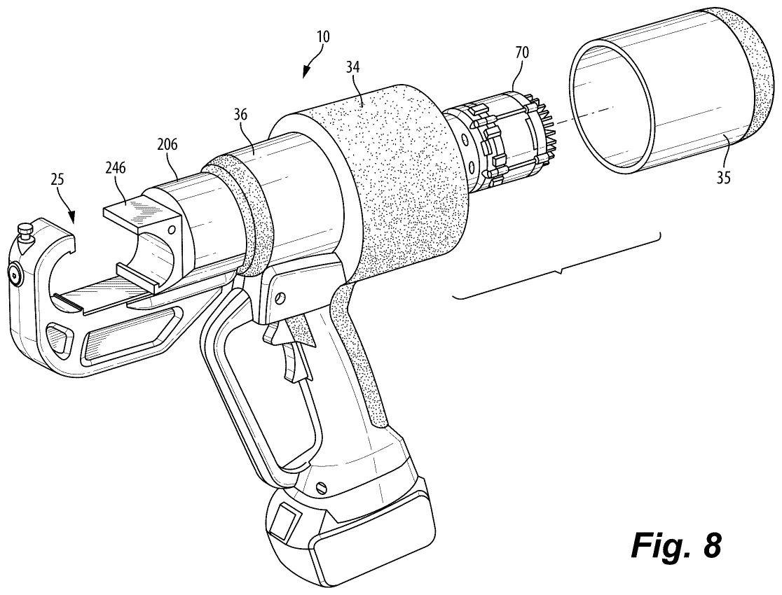

The main body portion 34 and neck portion 36 of pistol tool frame 32 are configured to house at least portions of the power unit 50. The neck portion 36 is also configured to receive and house a portion of the working head assembly (20 or 25) that couples the working head assembly to the power unit 50. The hand grip portion 38 is configured to be gripped by a user in one hand and includes one or more operator controls or actuators 40 and 42, which may be, for example switches and/or buttons. Depending on a particular embodiment, one or more cups or caps 35A-35C (e.g., see FIGS. 2A,2B) may be provided for covering a distal end of power unit 50 which extends from main body portion 34. The cups or caps 35 (35A, 35B, or 35C) may include a lip 351 that engages a proximal end 34B of main body portion 34 (see FIG. 6) providing a friction fit. Of course, other fits including threaded fits, the use of securing screws or pins, etc. are contemplated. As will be described in further detail below, power unit 50 is longitudinally movable within tool frame 32 for adjusting the center of gravity of the tool 10 depending on the working head (working head 20 or working head 25) that is attached to the tool 10. The distance the power unit 50 extends from main body portion 34 thus depends on the position of power unit 50 within tool frame 32. Accordingly, cups or caps 35A-35C (FIG. 2A) may be provided in varying lengths Cl such that the appropriate cup or cap can be selected and attached to main body portion 34 depending on how much of the power unit 50 extends from main body portion 34. Utilizing the shortest cup or cap (and thus lightest) available helps shift the center of gravity appropriately. Alternatively, it is contemplated that a cup or cap 35 can be provided sufficiently long such that it covers the distal end of power unit 50 regardless of the position of power unit 50 within tool frame 32.

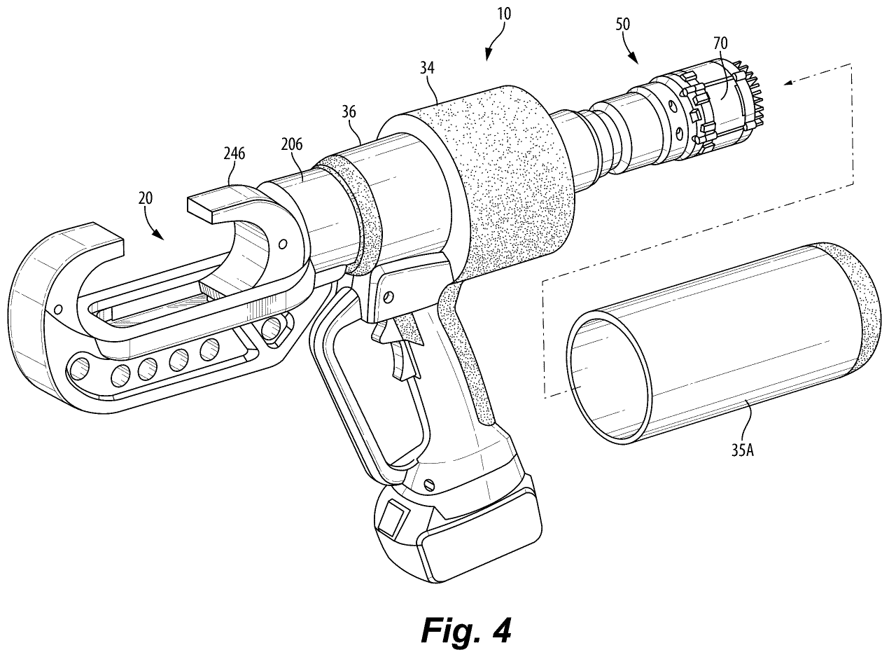

The one or more operator controls or actuators 40 and 42 can be manually activated by an operator. In the embodiment shown, the operator control 42 can be used to activate a motor 70 of the tool 10 to start an operating cycle of the tool 10, and the operator control 40 can be used to retract a ram 246 (FIG. 4) in the working head assembly (20, 25) of the tool 10 by activating a release member 162 of a pump assembly 140 (e.g., see FIG. 2B) as will be described in more detail below. One or both of the operator controls or actuators, e.g., switches 40 and/or 42, can be operably coupled to the controller 300 (FIG. 69). The hand grip portion 38 of the tool frame 32 may include a hand guard 44 that can protect an operator's hand while operating the tool 10.

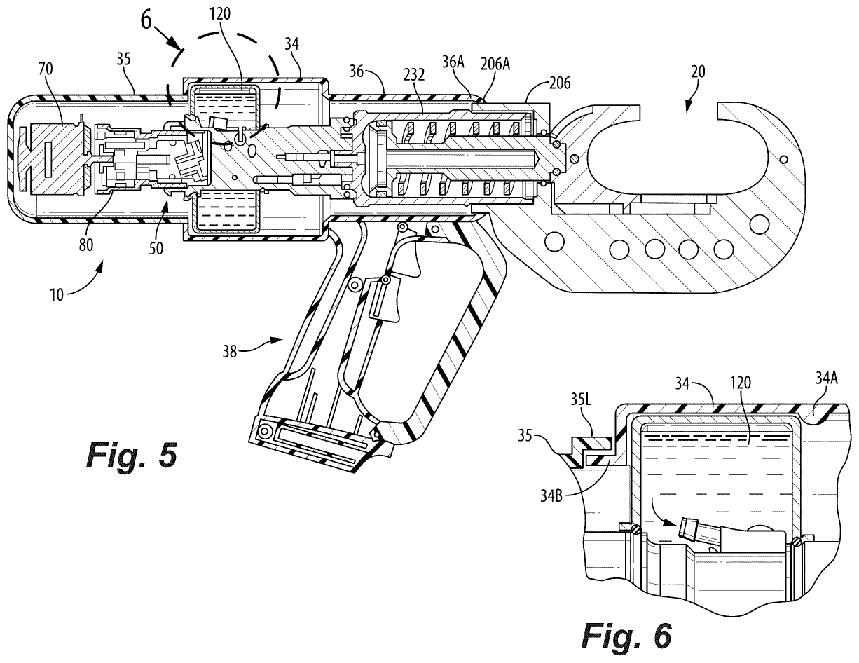

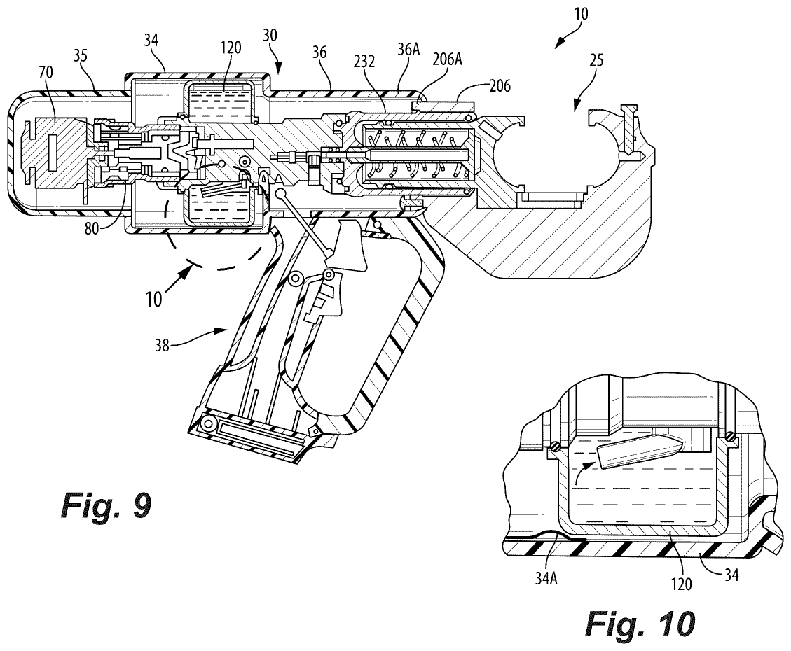

Various working head assemblies can be attached to the handle assembly 30 for performing various tasks. The various working head assemblies generally have different dimensions and weights. Referring to FIGS. 60 and 61, an exemplary embodiment of a working head 25 is shown. The working head 25 includes a cylindrical body 232 having a diameter “d”. The diameter of the cylindrical body 232 generally depends on the interior volume of the cylindrical body required to perform a particular task. For example, if the working head is a crimping head, the interior volume of the cylindrical body 232 may depend on the size of the crimps being crimped and the amount of force deemed necessary to perform the crimp operation. In addition, the overall length “L” of the working head 25 will generally vary depending on the size of the crimps being crimped and the amount of force deemed necessary to perform the crimp operation. For example, the diameter “d” of the cylindrical body 232 of modular working head 20 (FIG. 5) is generally greater than the diameter “d” of the cylindrical body 232 of modular working head 25 (FIGS. 9 and 60-68). Furthermore, the overall length (L) of the working head 20 is generally greater than the overall length (L) of the relatively smaller modular working head 25. Accordingly, depending on which working head assembly is attached to the handle assembly 30, the center of gravity of the tool 10 will change.

According to illustrative embodiments of the present disclosure, the center of gravity (CG) of tool 10 can be shifted so that it remains in substantially the same position while utilizing the various working heads (e.g., working heads 20, 25). For example, according to an embodiment of the present disclosure, the center of gravity of tool 10 can be maintained in the vicinity of the handle portion 38 (FIG. 3) and in particular, in the vicinity of the controls or actuators 40, 42 when utilizing a relatively larger and heavier modular working head 20 (e.g., see FIG. 1A and FIG. 5) or the relatively smaller and lighter modular working head 25 (e.g., see FIG. 1B and FIG. 7). According to illustrative embodiments of the present disclosure, this can be achieved by moving the position of the power unit 50 longitudinally within the handle assembly 30 depending on which working head is attached to the tool 10.

As shown in FIGS. 3-6, when working head 20 is attached to handle assembly 30, the proximal end 206a of flange or neck 206 of working head 20 is positioned within the distal end of neck portion 36a of handle assembly 30 (e.g., see FIG. 5). Power unit 50 is positioned back such that fluid reservoir 120 is in it rear most position within main body portion 34. The motor 70 (FIG. 2B) and transmission assembly 80 are covered and protected by cup or cap 35 which, as noted above, may be a removable and replaceable member. In this position, with the power unit 50 and fluid reservoir 120 positioned rearward, the center of gravity of the tool 10 is shifted back in handle assembly 30 away from hand grip portion 38 thus compensating for the larger and heavier working head 20. The center of gravity of tool 10 is thus positioned in the vicinity of the hand grip portion 38 of the tool 10 as depicted in FIG. 1A.

Referring to FIGS. 7-10, when the working head 20 is removed and working head 25 is attached to handle assembly 30, the proximal end 206a of flange or neck 206 of working head 25 is positioned within the distal end 36a of neck portion 36 of handle assembly 30 (e.g., see FIG. 9). Power unit 50 (FIG. 2B) is moved forward to connect to working head 25. In this position, fluid reservoir 120 is in it forward most position within main body portion 34. The motor 70 and a portion of transmission assembly 80 are covered and protected by cup or cap 35 which, as noted above, may be a removable and replaceable member. In this position, with the power unit 50 and fluid reservoir 120 positioned forward, the center of gravity of the tool 10 is shifted forward in handle assembly 30 towards hand grip portion 38 thus compensating for the smaller and lighter working head 25. The center of gravity of tool 10 is thus again positioned in the vicinity of the hand grip portion 38 of the tool 10 as depicted in FIG. 1B.

Various other working heads may be provided having dimensions and/or weights different than those of the exemplary working heads 20, 25 described herein. When these other working heads are connected to the handle assembly 30, the position of the power unit 50 within the neck portion 36 can be adjusted such that the fluid reservoir 120 will be positioned somewhere between the rearmost position depicted in FIG. 5 and the forward most position depicted in FIG. 9. In this way, the center of gravity of the tool 10 will remain in the vicinity of the hand grip portion 38 regardless of the working head attached to the tool 10.

The power unit 50 may be fixed and prevented from moving in the lateral direction within handle assembly 30 in various ways. For example, one or more detents or stops 34A (see FIG. 6 and FIG. 10) may be provided along the inner surface of main body portion 34 of tool frame 32. Main body portion 34 of tool frame 32 has sufficient flex so that as power unit 50 is being moved to its rear most position in hand assembly 30 depicted in FIG. 5, as the fluid reservoir 120 contacts detent or stop 34A, the main body portion 34 will deflect outward, allowing the fluid reservoir 120 to be positioned. Once the fluid reservoir 120 clears the detent or stop 34A, the main body portion 34 will return to its original position and secure the power unit 50 in its rearward most position to receive working head 20 (see FIG. 6). To position the power unit 50 to receive working head 25, power unit 50 can be pushed forward within hand assembly 30 so that fluid reservoir 120 will contact detent or stop 34A, deflecting main body portion 34 outward, allowing the fluid reservoir 120 to be positioned. Once the fluid reservoir 120 clears the detent or stop 34A, the main body portion 34 will return to its original position and secure the power unit 50 in its forward most position to receive working head 25 (see FIG. 10).

Of course, other mechanisms may be utilized to fix the power unit 50 is position within tool 10. As will be described in more detail later below with respect to FIG. 67, pins 266 are used to mate the piston assembly 230 of the working head 25 to the pump assembly 140 of power unit 50, allowing the working head 25 to rotate. According to an embodiment of the present disclosure, one or more sets of holes 30a may be provided in neck portion 36 of tool frame 32 (e.g., see FIG. 3). When the power unit 50 is properly positioned to mate with the piston assembly 230 of working head 25, the pins 266 can be passed through the holes 30a in the neck portion 36 of tool frame 32 and then passed through the openings 50a in the housing of the pump assembly 140. The pins 266 are of sufficient length to mate the piston assembly 230 of the working head to the pump assembly 140 and to the tool frame 32.

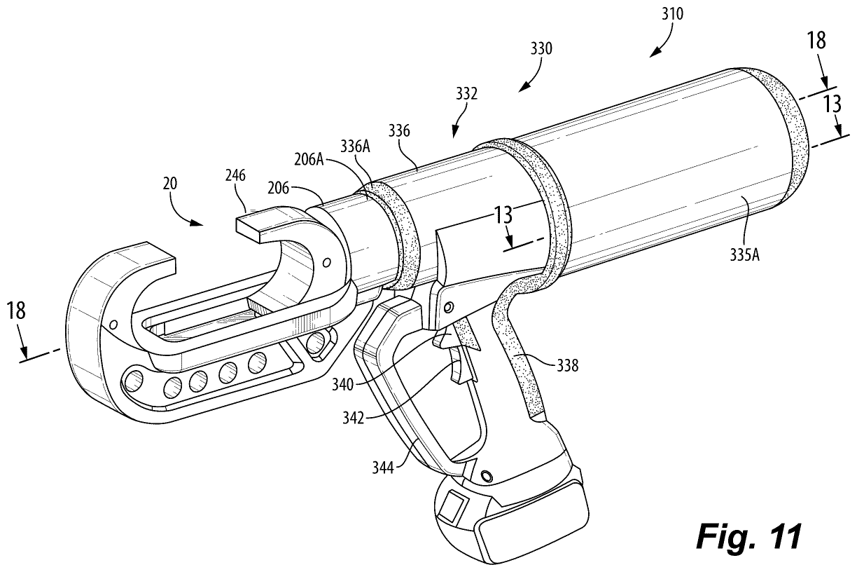

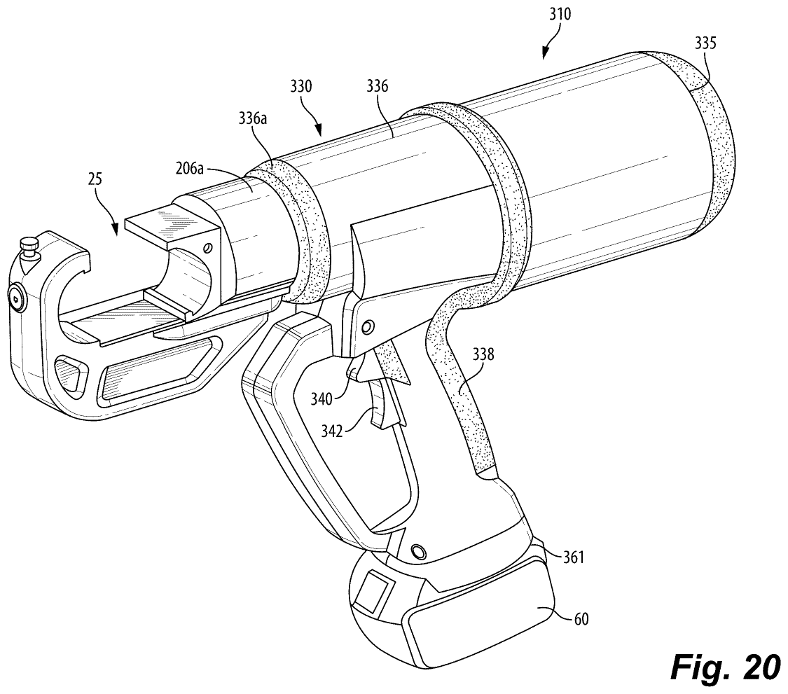

A tool 310 according to other illustrative embodiments of the present disclosure is depicted in FIGS. 11-21. Tool 310 includes a handle assembly 330 that may have various modular working head assemblies attached thereto, each working head assembly for performing a different task. For example, as depicted in FIG. 11, a first modular working head assembly 20 for crimping connectors of a first size or size range is operatively connected to tool 310. As depicted in FIG. 20, the first modular working head assembly 20 has been removed from tool 310 and replaced with a second modular working head assembly 25 for crimping connectors of a second size or size range.

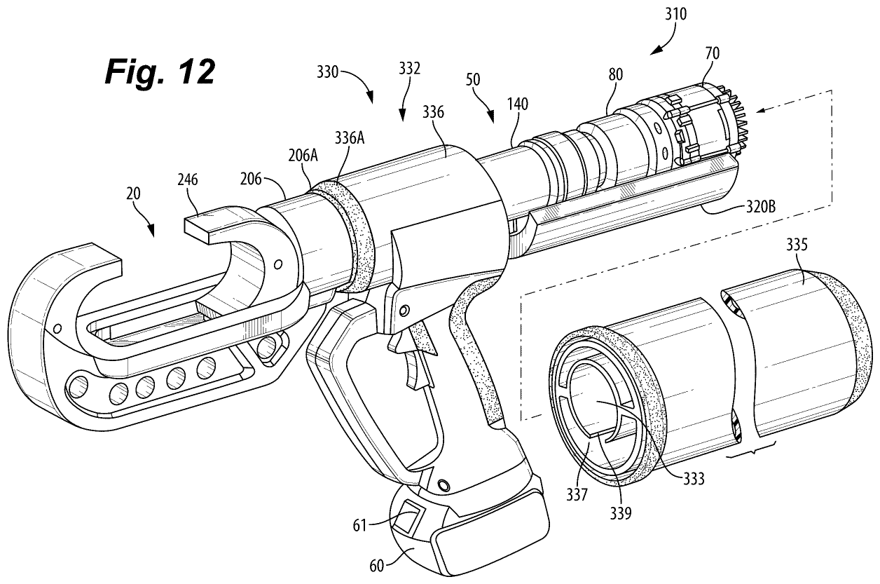

Handle assembly 330 may have various configurations. According to an illustrative embodiment of the present disclosure as depicted in FIG. 11, handle assembly 330 includes a pistol type tool frame 332, allowing the user to hold and operate tool 310 with one hand. A replaceable cup or cap 335A covers a portion of the inner workings of the tool 310. Pistol type tool frame 332 has a neck portion 336 and a hand grip portion 338. The handle assembly 330 houses a modular power unit 50, a portion of which is depicted in FIG. 12. Power unit 50 is similar in most respects to that described above and later below. According to the present illustrative embodiments, instead of the circular fluid reservoirs described with respect to the above embodiments, the fluid reservoirs in the present embodiment are semi-circular and removably attachable to power unit 50. Handle assembly 330 also houses a controller 300 (FIG. 69) that provides electrical controls for the tool, an attachment port 361 for receiving a replaceable battery 60 and other components of the tool 310. The pistol type tool frame 332 may be a two-part housing that when joined together form one or more cavities or compartments configured to receive the modular power unit 50 (FIG. 12), the controller, battery attachment port 361 and the other components of the tool 310.

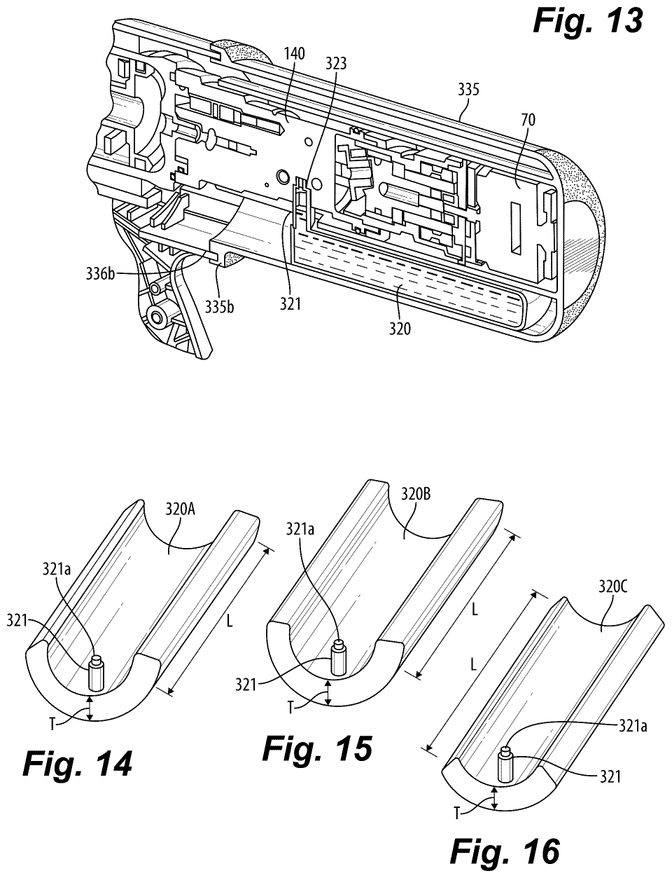

The neck portion 336 of tool frame 332 is configured to house at least portions of the power unit 50. The neck portion 336 is also configured to receive and house a portion of the working head assembly (20 or 25) that couples the working head assembly to the power unit 50 as will be described later below. The hand grip portion 338 is configured to be gripped by a user in one hand and includes one or more operator controls or actuators 340 and 342, which may be, for example switches and/or buttons. Depending on a particular embodiment, one or more cups or caps 335A-335C (e.g., see FIGS. 11-18, 20, 21) may be provided allowing the user to select a cap or cover for covering a distal end of power unit 50 as well as portions of the fluid reservoir 320 (FIG. 13) which extends from the neck portion 336 of tool frame 332. As will be described in further detail below, the fluid reservoir 320 is removably attached to power unit 50 and is replaceable with differently configured fluid reservoirs designed to compensate for the different weights and configurations of the working heads that may be attached to the tool 310. By replacing the fluid reservoir with a fluid reservoir corresponding to the attached working head, the center of gravity of the tool 310 can be maintained in the vicinity of the handle portion 338 regardless of which working head is attached. According to various embodiments, the power unit 50 may or may not be longitudinally movable within tool frame 332 for further adjusting the center of gravity of the tool 310 depending on the working head that is attached to the tool 310. The distance the power unit 50 extends from neck portion 336 may thus depend on the position of power unit 50 within tool frame 332. Accordingly, cups or caps 335 of varying lengths may be provided such that the appropriate cup or cap can be selected and attached to neck portion 336 depending on how much of the power unit 50 extends from neck portion 336. As will be described later below, the interior of one or more of the cups or caps 335 may be partitioned or sectioned off to accommodate and support various differently configured fluid reservoirs. According to an embodiment of the present disclosure a cup or cap 335 can be provided which is of sufficient length that it covers the distal end of power unit 50 and fluid reservoir 320 regardless of their positions within tool frame 332.

The one or more operator controls or actuators 340 and 342 can be manually activated by an operator. In the embodiment shown, the operator control 342 can be used to activate the power unit 50 to start an operating cycle of the tool 310. The operator control 340 can be used to retract a ram 246 in the working head assembly (20, 25) of the tool 310 by activating a release member 162 of a pump assembly 140 similar to that described with respect to FIG. 2B and as will be described in more detail below. One or both of the operator controls or actuators, e.g., switches 340 and/or 342, can be operably coupled to the controller 300. The hand grip portion 338 of the tool frame 332 may include a hand guard 344 that can protect an operator's hand while operating the tool 310.

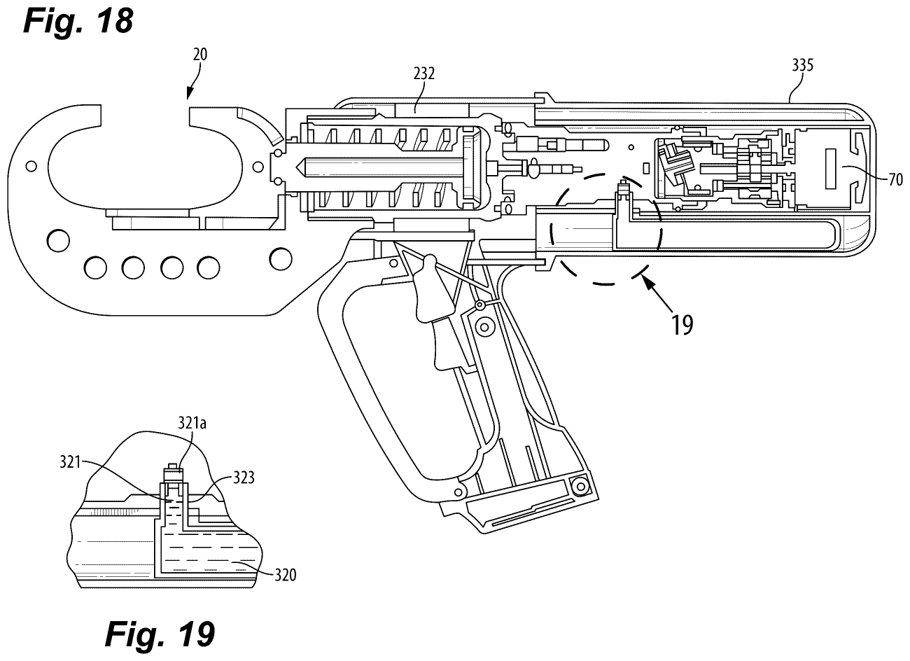

As described above with respect to other embodiments, various working head assemblies can be attached to the handle assembly 330 for performing various tasks. The various working head assemblies generally have different dimensions and weights. Referring to FIGS. 60 and 62, an exemplary embodiment of a working head 25 is shown. The working head 25 includes a cylindrical body 232 having a diameter “d”. The diameter of the cylindrical body 232 generally depends on the interior volume of the cylindrical body 232 required to perform a particular task. For example, if the working head is a crimping head, the interior volume of the cylindrical body 232 may depend on the size of the crimps being crimped and the amount of force deemed necessary to perform the crimp operation. In addition, the overall length “L” of the working head 25 will generally vary depending on the size of the crimps being crimped and the amount of force deemed necessary to perform the crimp operation. For example, the diameter “d” of the cylindrical body 232 of modular working head 20 (FIG. 18) is generally greater than the diameter “d” of the cylindrical body 232 of modular working head 25 (FIG. 60). Furthermore, the overall length (L) of the working head 20 is generally greater than the overall length (L) of the relatively smaller modular working head 25. Accordingly, depending on which working head assembly is attached to the handle assembly 330 (FIG. 11), the center of gravity of the tool 310 will change.

According to illustrative embodiments of the present disclosure, the center of gravity of tool 310 can be shifted so that it remains in substantially the same position while utilizing the various working heads (e.g., working heads 20, 25). For example, according to an embodiment of the present disclosure, the center of gravity of tool 310 can be maintained in the vicinity of the handle portion 338 and in particular, in the vicinity of the controls or actuators 340, 342 when utilizing a relatively larger and heavier modular working head 20 (FIG. 12) or the relatively smaller and lighter modular working head 25 (FIG. 7). According to illustrative embodiments of the present disclosure, this can be achieved by changing the fluid reservoir 320 attached to the power unit 50 and/or by moving the position of the power unit 50 longitudinally within the handle assembly 330 depending on which working head is attached to the tool 310.

As shown in FIG. 11, when working head 20 is attached to handle assembly 330, the proximal end 206a of flange or neck 206 of working head 20 is positioned within the distal end 336a of neck portion 336 of handle assembly 330. As shown in FIGS. 12 and 13, a portion of the power unit 50 extends from the handle assembly 330. According to the present illustrative embodiment, power unit 50 is positioned within handle assembly 330 so that a fluid port 323 (FIG. 13) provided in power unit 50 is exposed and readably accessible to an end user. This allows the end user to attach a desired fluid reservoir 320 to the power unit 50 as appropriate. According to another embodiment, the power unit 50 can be retracted or removed from the handle assembly 330 and the appropriate fluid reservoir 320 attached to power unit 50 via fluid port 323. The power unit and fluid reservoir 320 can then be inserted into handle assembly 330 and mated with working head 20.

According to illustrative embodiments of the present disclosure, the center of gravity of the tool 310 can thus be adjusted to compensate for the different modular working heads by swapping out the fluid reservoir 320 attached to the power unit 50 and/or be longitudinally shifting the power unit 50 within neck portion 336. Examples of various replaceable fluid reservoirs that may be provided and attached to power unit 50 are shown in FIGS. 14-16. The fluid reservoirs are generally semi-circular in shape, although other shapes are contemplated. For example, the fluid reservoirs may include a one-third circumference (120 degrees) fluid reservoir 320A as shown in FIG. 14, a one-half circumference (e.g., 180 degrees) fluid reservoir 320B as shown in FIG. 15 and a one-quarter circumference (e.g., 90 degrees) fluid reservoir 320C as shown in FIG. 16. The fluid reservoirs 320A-320C may have the same thickness (T) and/or the same length (L). Alternatively, the fluid reservoirs 320A-320C may have different thicknesses (T) and/or lengths. (L). The particular shape and size of the fluid reservoirs as described herein can vary depending on the shape and weight of the corresponding working head unit the fluid reservoir is intended to work with in order to shift the center of gravity of the tool to be in the vicinity of the controls or actuators 340 and 342 of tool 310. Accordingly, when the working head unit is changed on the tool 310, a corresponding fluid reservoir can be inserted and attached to the power unit 50 which is designed to balance the tool 310 and to properly position the center of gravity of the tool 310.

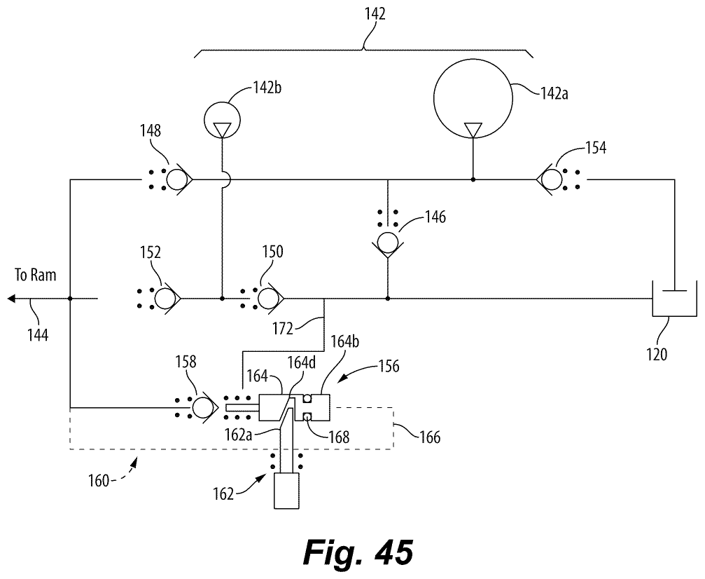

Each fluid reservoir 320A-320C may include a check valve 321a providing a self-sealing nipple or valve stem 321 so that fluid is contained within the fluid reservoir when not attached to the power unit 50. The self-sealing nipple or valve stem 321 extends perpendicular to the inner surface of the semi-circular shaped fluid reservoir. The pump assembly 140 of power unit 50 includes a fluid port 323 dimensioned to receive the self-sealing nipple or valve stem 321. The fluid port 323 may include a check valve and be self-scaling so that no fluid leaks therefrom when the self-sealing nipple or valve stem 321 of the fluid reservoir 320 is not positioned therein. As will be appreciated from the detailed description later below with respect to FIG. 45, when attached to power unit 50, the fluid reservoir 320 is in fluid communication with low pressure inlet check valve 146 and high pressure inlet check valve 150. The fluid port 323 (FIG. 13) may include one or more O-rings (not shown) for providing a sealing closure around the self-closing nipple or valve stem 321. A fluid reservoir (320A FIG. 14, 320B FIG. 15, 320C FIG. 16) can be positioned next to power unit 50 so that the self-sealing nipple or valve stem 321 is aligned with the fluid port 323 in pump assembly 140 of power unit 50. The fluid reservoir 320 is then pressed toward power unit 50 until the self-sealing nipple or valve stem 321 is seated within fluid port 323. In the seated position, fluid in fluid reservoir 320 can be utilized by the pump assembly 140 provided in power unit 50. When the fluid reservoir 320 is removed from the power unit 50, the self-sealing nipple or valve stem 321 provides a scaling closure preventing leakage of the fluid from the fluid reservoir 320.

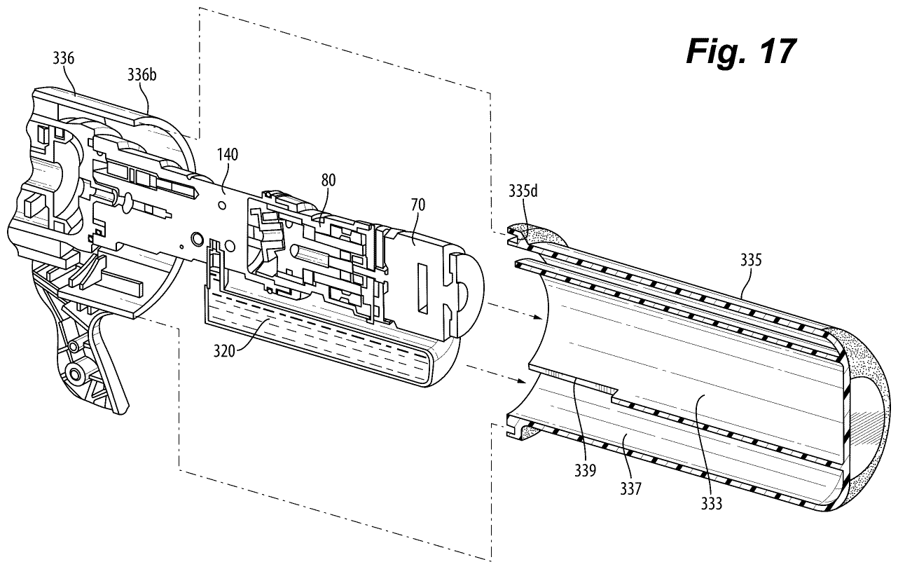

A cap or cup 335 for covering the power unit 50 and fluid reservoir extending from the rear portion of the tool 310 is depicted in FIG. 12. The cap or cup 335 is tubular and substantially circular in cross-section and may include separate compartments or chambers. For example, as shown in FIG. 12, cap or cup 335 may include an interior semicircular chamber 337 for receiving the fluid reservoir 320B. According to the present illustrative embodiment, the semicircular chamber 337 extends one half the circumference of the cap or cup 335 allowing it to receive any of the fluid reservoirs described with respect to FIGS. 14-16. For example, the semicircular chamber 337 is capable of receiving the one-third circumference fluid reservoir 320A (FIG. 14), the one-half circumference fluid reservoir 320B (FIG. 15) and the one-quarter circumference fluid reservoir 320C (FIG. 16). In addition, a circular chamber 333 may be provided adjacent to the semicircular chamber 337 for receiving one or more portions of the power unit 50 including, for example, motor 70, transmission assembly 80 and pump assembly 140 which may extend from the handle assembly 330 (e.g., see FIG. 11). Chamber 333 may include a notch 339 for receiving the self-scaling nipple or valve stem 321 extending from fluid reservoir 320 (e.g., see FIG. 12). As shown in FIG. 17, the open end of cup or cap 335 includes a C-shaped edge 335d dimensioned to receive the proximal end 336b of neck portion 336 and provide a friction fit of cup or cap 335 to neck portion 336 of tool 310.

The power unit 50 may be fixed and prevented from moving in the longitudinal direction within handle assembly 330 in various ways. For example, as described above with respect to earlier embodiments as will be described in more detail later below with respect to FIG. 67, pins 266 are used to mate the piston assembly 230 of the working head 25 to the pump assembly 140 of power unit 50, allowing the working head 20, 25 to rotate. According to an embodiment of the present disclosure, one or more sets of holes (not shown) may be provided in neck portion 336 of tool frame 332. When the power unit 50 is properly positioned to mate with the piston assembly 230 of working head 20 or working head 25, the pins 266 can be passed through the holes in the neck portion 336 of tool frame 332 and then passed through the openings 50a in the housing of the pump assembly 140. The pins 266 are of sufficient length to mate the piston assembly 230 of the working head to the pump assembly 140 and to the tool frame 332.

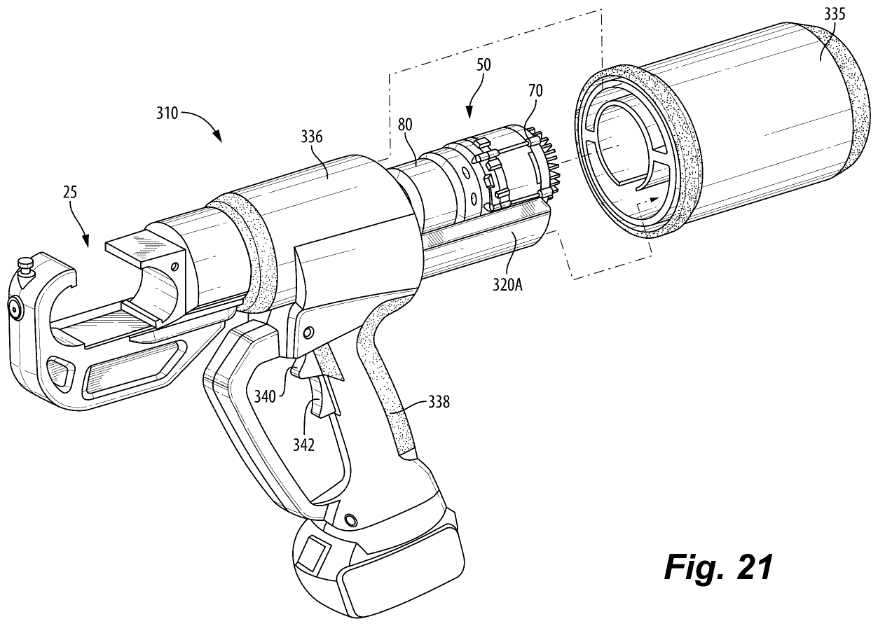

FIGS. 20 and 21 depict tool 310 after working head 20 has been removed and replaced with working head 25. The one-half circumference fluid reservoir 320B (see FIG. 15) has been replaced with the one-third circumference fluid reservoir 320A (see FIG. 14) to compensate for the lighter and smaller working head 25 and move and maintain the center of gravity of tool 310 in the vicinity of the handle grip portion 338 and in particular, in the vicinity of the controls or actuators 340 and 342 of tool 310. As shown in FIG. 21, when working head 25 is attached to power unit 50, only the motor 70, a portion of transmission 80 and a portion of the fluid reservoir 320A extends from the rear of neck portion 336. The cup or cap 335A depicted in FIG. 11 has been replaced with the shorter (and thus lighter) cup or cap 335B further adjusting the center of gravity of the tool 310.

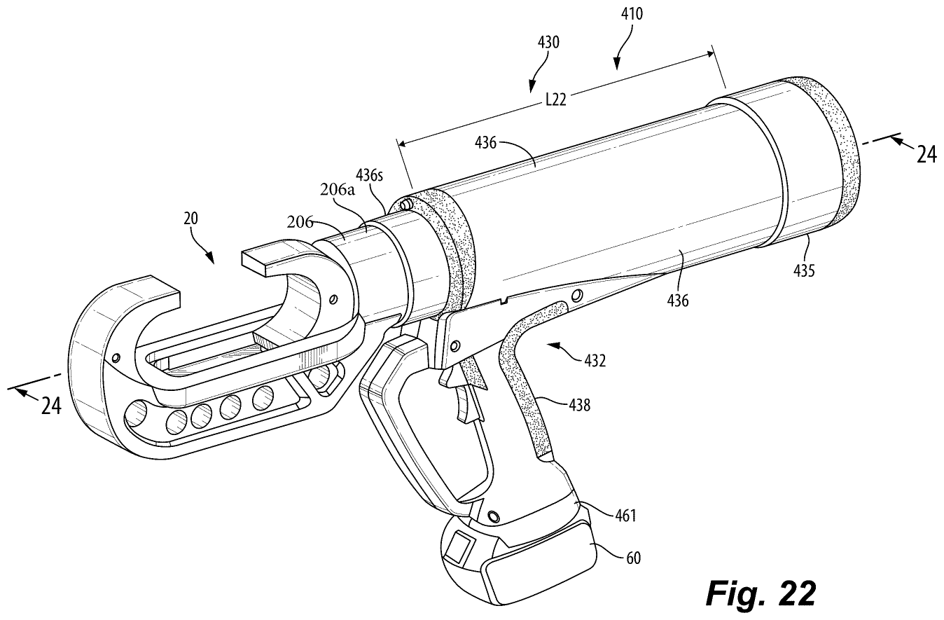

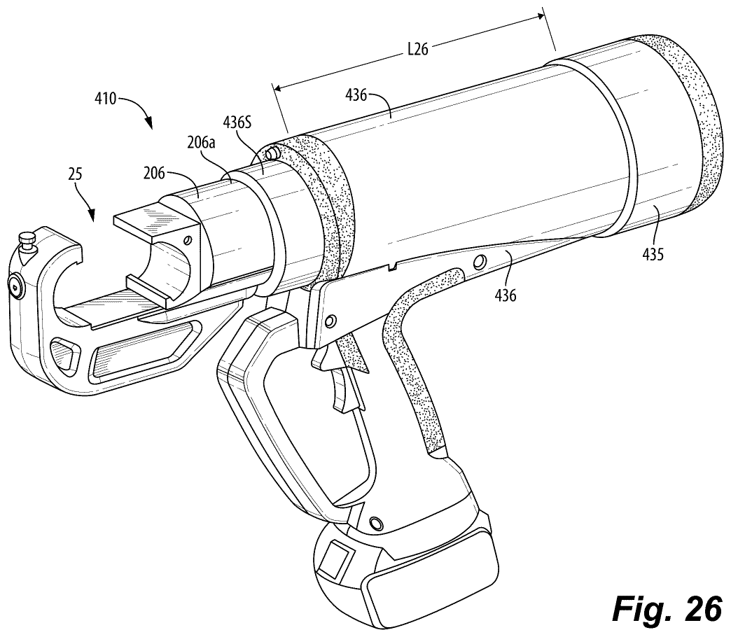

A tool 410 according to other illustrative embodiments of the present disclosure is depicted in FIGS. 22-26. Tool 410 includes a handle assembly 430 that may have various modular working head assemblies attached thereto, each working head assembly for performing a different task. For example, as depicted in FIG. 22, a first modular working head assembly 20 for crimping connectors of a first size or size range is operatively connected to tool 410. As depicted in FIG. 26, the first modular working head assembly 20 has been removed from tool 410 and replaced with a second modular working head assembly 25 for crimping connectors of a second size or size range.

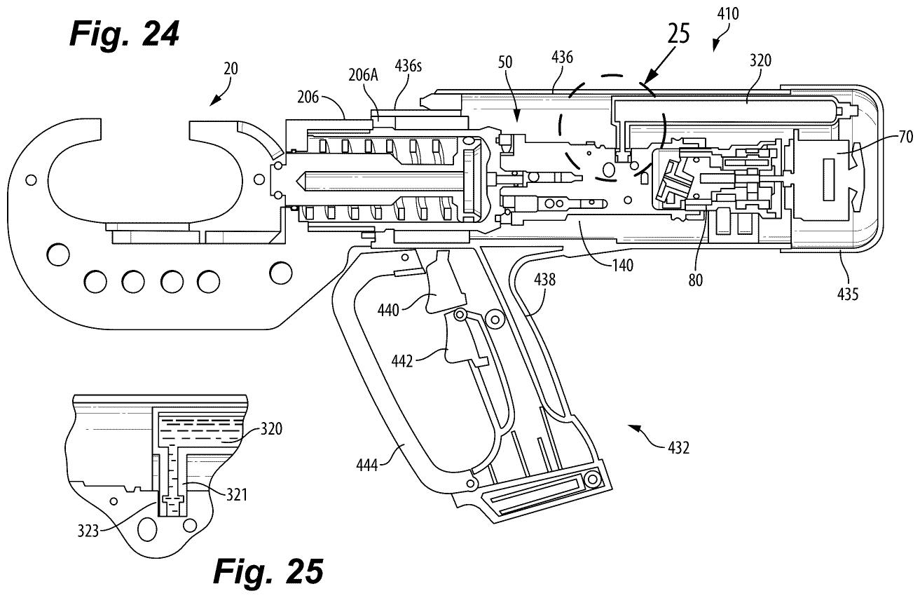

Handle assembly 430 may have various configurations. According to an illustrative embodiment of the present disclosure as depicted in FIG. 22, handle assembly 430 includes a pistol type tool frame 432, allowing the user to hold and operate tool 410 with one hand. A replaceable cup or cap 435 covers a portion of the inner workings of the tool 410. Pistol type tool frame 432 has a neck portion 436 and a hand grip portion 438. The handle assembly 430 houses a modular power unit 50, a portion of which is depicted in FIG. 24. Handle assembly 430 also houses a controller 300 (FIG. 69) that provides electrical controls for the tool 410, an attachment port 461 for receiving a replaceable battery 60 and other components of the tool 410. The pistol type tool frame 432 may be a two-part housing that when joined together form one or more cavities or compartments configured to receive the modular power unit 50, the controller 300, battery attachment port 461 and the other components of the tool 410.

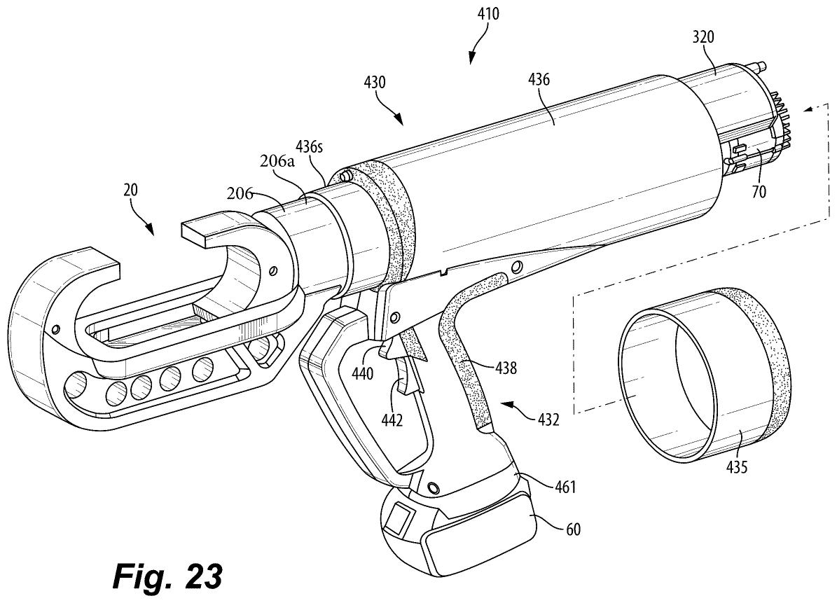

The neck portion 436 of tool frame 432 has a length “L” notably longer than the neck portions described with respect to other embodiments described herein and is configured to house most of the portions of the power unit 50, when the larger modular working head assembly 20 or the smaller modular working head assembly 25 is attached to tool 410. As depicted in FIG. 23, the motor 70 and a portion of fluid reservoir 320A (FIG. 14) extends from neck portion 436 of tool 410. The neck portion 436 is also configured to receive and house a portion of the working head assembly (20 or 25) that couples the working head assembly to the power unit 50 as will be described later below. The hand grip portion 438 is configured to be gripped by a user in one hand and includes one or more operator controls or actuators 440 and 442, which may be, for example switches and/or buttons. According to the present embodiment, only one cup or cap is required for covering the end of neck portion 436 regardless of which working head assembly (20 or head assembly 25) is attached to tool 410.

The fluid reservoir 320 is removably attached to power unit 50 and is replaceable with differently configured fluid reservoirs designed to compensate for the different weights and configurations of the working heads that may be attached to the tool 410. By replacing the fluid reservoir with a fluid reservoir corresponding to the attached working head, the center of gravity of the tool 410 can be maintained in the vicinity of the handle portion 438 and in particular, in the vicinity of the controls or actuators 440 or actuator 442 regardless of which working head is attached. According to the present embodiment, the power unit 50 is longitudinally movable within tool frame 432 for further adjusting the center of gravity of the tool 410 depending on the working head that is attached to the tool 410. The distance the power unit 50 extends from neck portion 434 thus depends on the position of power unit 50 within tool frame 432.

The one or more operator controls or actuators 440 and 442 can be manually activated by an operator. In the embodiment shown, the operator control 442 can be used to activate the power unit 50 to start an operating cycle of the tool 410. The operator control 440 can be used to retract a ram 246 in the working head assembly 20 or working head assembly 25 of the tool 410 by activating a release member 162 of a pump assembly 140 similar to that described with respect to FIG. 2B and as will be described in more detail below. One or both of the operator controls or actuators, e.g., switches 440 and/or 442, can be operably coupled to the controller 300. The hand grip portion 438 of the tool frame 432 may include a hand guard 444 that can protect an operator's hand while operating the tool 410.

As described above with respect to other embodiments, various working head assemblies can be attached to the handle assembly 430 for performing various tasks. The various working head assemblies generally have different dimensions and weights. Referring to FIGS. 60 and 61, an exemplary embodiment of a working head 25 is shown. The working head 25 includes a cylindrical body 232 having a diameter “d”. The diameter of the cylindrical body 232 generally depends on the interior volume of the cylindrical body 232 required to perform a particular task. For example, if the working head is a crimping head, the interior volume of the cylindrical body 232 may depend on the size of the crimps being crimped and the amount of force deemed necessary to perform the crimp operation. In addition, the overall length “L” of the working head 25 will generally vary depending on the size of the crimps being crimped and the amount of force deemed necessary to perform the crimp operation. For example, the diameter “d” of the cylindrical body 232 of modular working head 20 (FIG. 5) is generally greater than the diameter “d” of the cylindrical body 232 of modular working head 25 (FIG. 60). Furthermore, the overall length (L) of the working head 20 is generally greater than the overall length (L) of the relatively smaller modular working head 25. Accordingly, depending on which working head assembly is attached to the handle assembly 430, the center of gravity of the tool 410 will change. According to illustrative embodiments of the present disclosure, the center of gravity of tool 410 can be shifted so that it remains in substantially the same position while utilizing the various working heads (e.g., working heads 20, 25). For example, according to an embodiment of the present disclosure, the center of gravity of tool 410 can be maintained in the vicinity of the handle portion 438 and in particular, in the vicinity of the controls or actuators 440, 442 when utilizing a relatively larger and heavier modular working head 20 (FIG. 12) or the relatively smaller and lighter modular working head 25 (FIG. 20). According to illustrative embodiments of the present disclosure, this can be achieved by changing the fluid reservoir 320 attached to the power unit 50 and/or by moving the position of the power unit 50 longitudinally within the handle assembly 430 depending on which working head is attached to the tool 410.

As shown in FIGS. 22, 23, and 24, neck portion 436 includes a stepdown collar 436s dimensioned to receive the distal end portion 206a of flange or neck 206 of working head 20. As shown in FIGS. 23 and 24, a portion of power unit 50 extends from the handle assembly 430 According to the present illustrative embodiment, prior to connecting a working head 20 or working head 25, power unit 50 may be withdrawn from neck portion 436 and an appropriately sized fluid reservoir 320 attached to the power unit 50. The power unit 50 and attached fluid reservoir 320 can then be reinserted into the neck portion 436 and the selected working head attached to the power unit 50.

Examples of various replaceable fluid reservoirs that may be provided and attached to power unit 50 are shown in FIGS. 14-16. According to the present embodiment, the fluid reservoirs may be attached to an end portion of power unit 50 as depicted in FIG. 24. The fluid reservoirs are generally semi-circular in shape, although other shapes are contemplated. For example, the fluid reservoirs may include a one-third circumference fluid reservoir 320A as shown in FIG. 14, a one-half circumference fluid reservoir 320B as shown in FIG. 15 and a one-quarter circumference fluid reservoir 320C as shown in FIG. 16. The fluid reservoirs 320A-320C may have the same thickness (T) and/or the same length (L). Alternatively, the fluid reservoirs 320A-320C may have different thicknesses (T) and/or lengths. (L). The particular shape and size of the fluid reservoirs as described herein can vary depending on the shape and weight of the corresponding working head unit the fluid reservoir is intended to work with in order to shift the center of gravity of the tool to be in the vicinity of the controls or actuator 440 or actuator 442 of tool 410. Accordingly, when the working head unit is changed on the tool 410, a corresponding fluid reservoir can be inserted and attached to the power unit 50 which is designed to balance the tool 410 and to properly position the center of gravity of the tool 410.

Each fluid reservoir 320A-320C may include a check valve 321a providing a self-scaling nipple or valve stem 321 so that fluid is contained within the reservoir when not attached to the power unit 50. The self-sealing nipple or valve stem 321 extends perpendicular to the inner surface of the semi-circular shaped fluid reservoir. The pump assembly 140 of power unit 50 includes a fluid port 323 dimensioned to receive the self-closing nipple or valve stem 321. The fluid port 323 may include a check valve and be self-sealing so that no fluid leaks therefrom when the self-sealing nipple or valve stem 321 of the fluid reservoir 320 is not positioned therein. As will be appreciated from the detailed description later below with respect to FIG. 45, when attached to power unit 50, fluid reservoir 320 is in fluid communication with low pressure inlet check valve 146 and high pressure inlet check valve 150. The fluid port 323 (FIG. 13) may include one or more O-rings (not shown) for providing a sealing closure around the self-closing nipple or valve stem 321. A fluid reservoir (320A FIG. 14, 320B FIG. 15, 320C FIG. 16) can be positioned next to power unit 50 so that the self-sealing nipple or valve stem 321 is aligned with the fluid port 323 in pump assembly 140 of power unit 50. The fluid reservoir 320 is then pressed toward power unit 50 until the self-sealing nipple or valve stem 321 is seated within fluid port 323. In the seated position, fluid in fluid reservoir 320 can be utilized by the pump assembly 140 provided in power unit 50. When the fluid reservoir 320 is removed from the power unit 50, the self-sealing nipple or valve stem 321 provides a sealing closure preventing leakage of the fluid from the fluid reservoir 320.

A cap or cup 435 for covering the power unit 50 and fluid reservoir extending from the rear portion of the tool 410 is depicted in FIGS. 23 and 24. The cap or cup 435 is tubular and substantially circular in cross-section. When the larger working head 20 is attached to tool 410 as shown in FIGS. 23 and 24, the cap or cup 435 is dimensioned to be press fit to the end of neck portion 436 to cover power unit 50 and fluid reservoir 320. It will be appreciated that when the smaller working head 25 is attached to tool 410, the power unit is shifted forward in the neck portion 436 such that little if any of the power unit 50 and fluid reservoir 320 will extend past the rear portion of the tool 410. In this case, the cap or cup 435 can be press fit even further onto the neck portion 436 to cover the open end of tool 410 as depicted in FIG. 26.

The power unit 50 may be fixed and prevented from moving in the longitudinal direction within handle assembly 430 in various ways. For example, as described above with respect to earlier embodiments as will be described in more detail later below with respect to FIG. 67, pins 266 are used to mate the piston assembly 230 of the working head 25 to the pump assembly 140 of power unit 50, allowing the working head 20 or working head 25 to rotate. According to an embodiment of the present disclosure, one or more sets of holes (not shown) may be provided in neck portion 436 of tool frame 432. When the power unit 50 is properly positioned to mate with the piston assembly 230 of working head 20 or working head 25, the pins 266 can be passed through the holes in the neck portion 436 of tool frame 432 and then passed through the openings 50a (FIG. 67) in the housing of the pump assembly 140. The pins 266 are of sufficient length to mate the piston assembly 230 of the working head to the pump assembly 140 and to the tool frame 432.

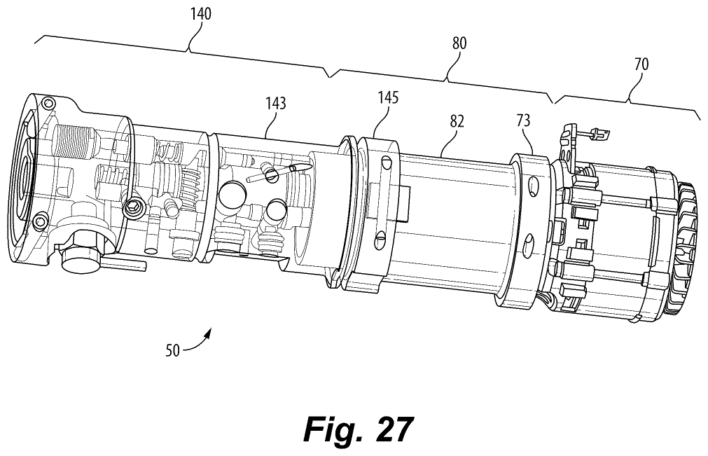

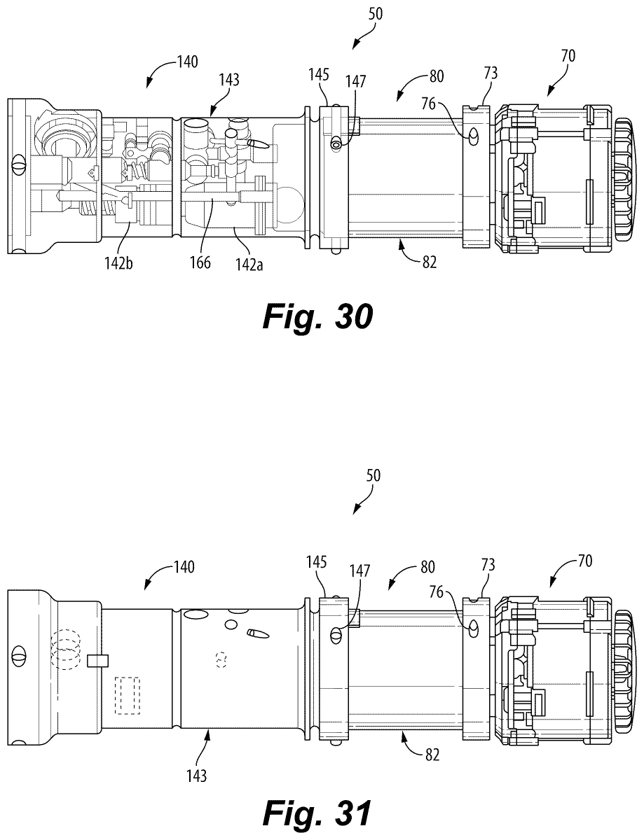

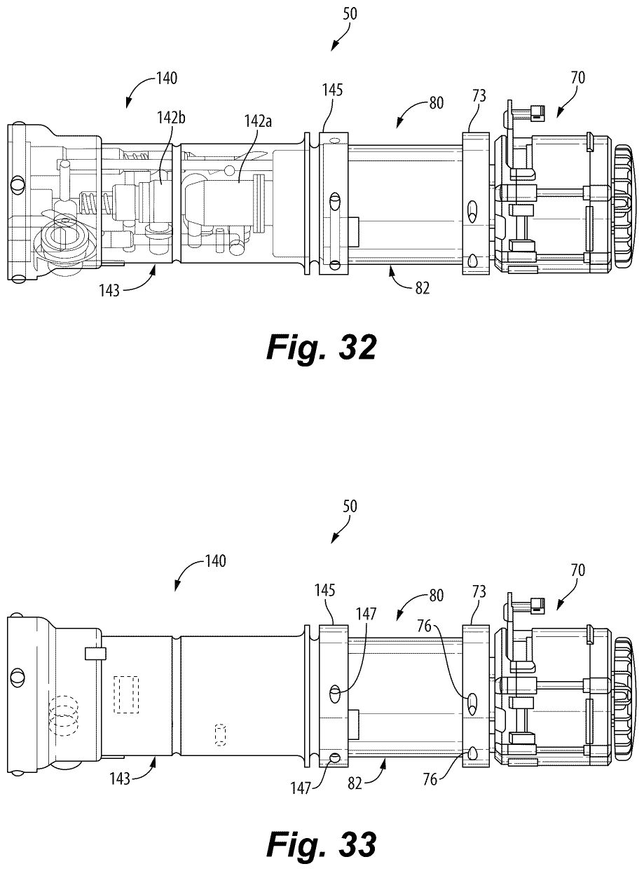

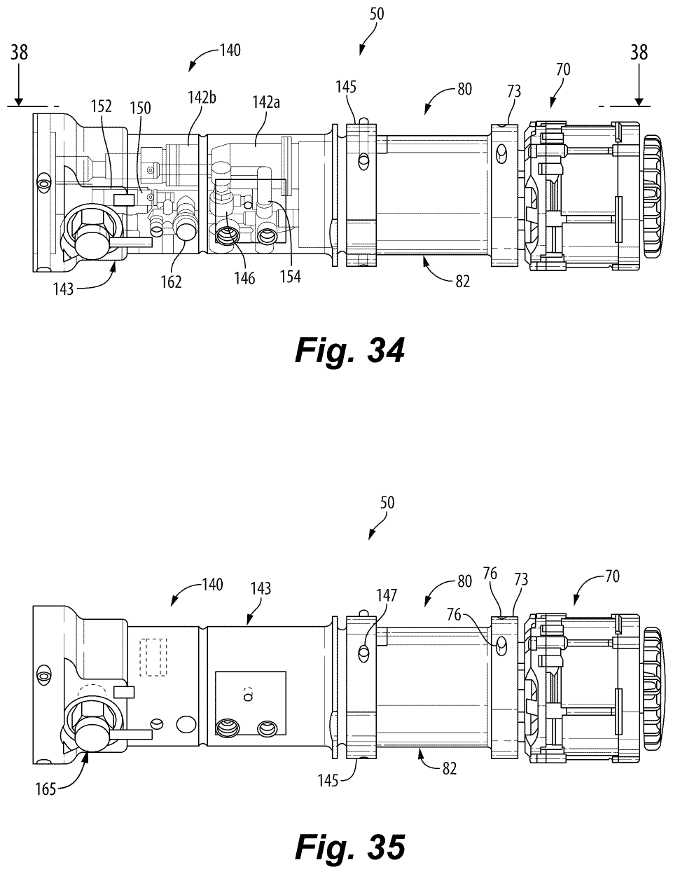

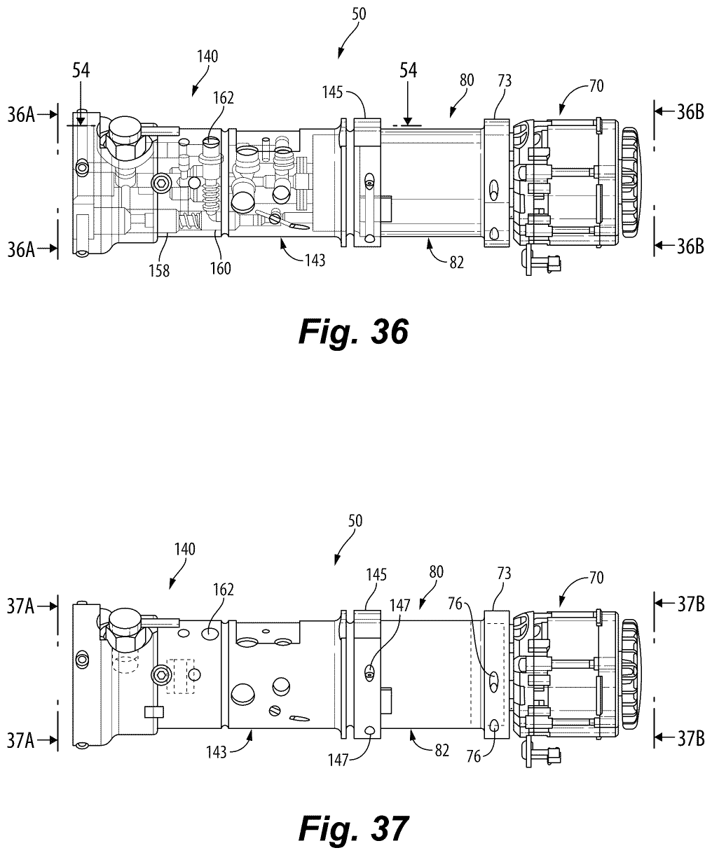

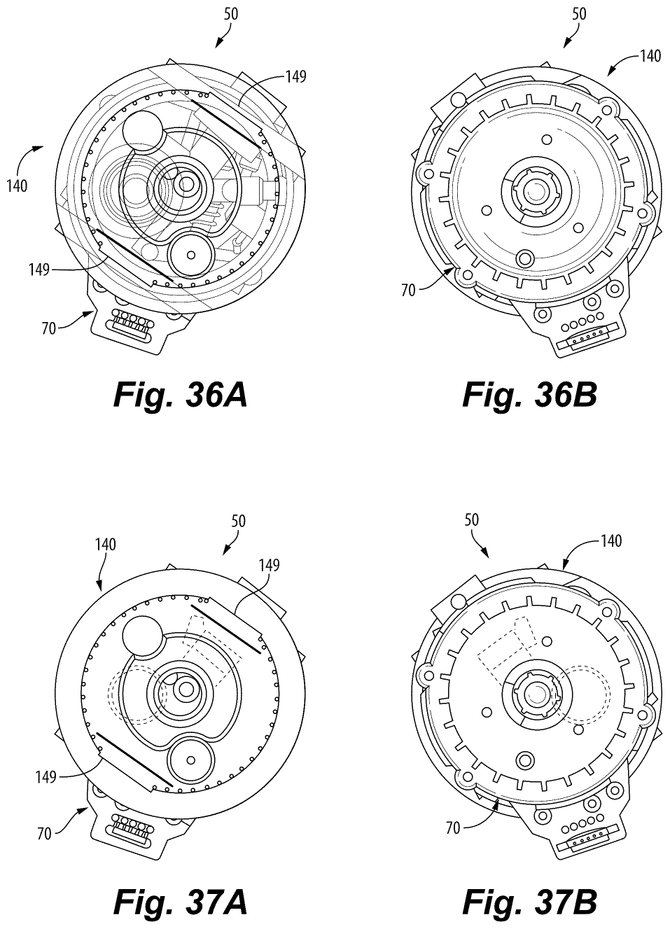

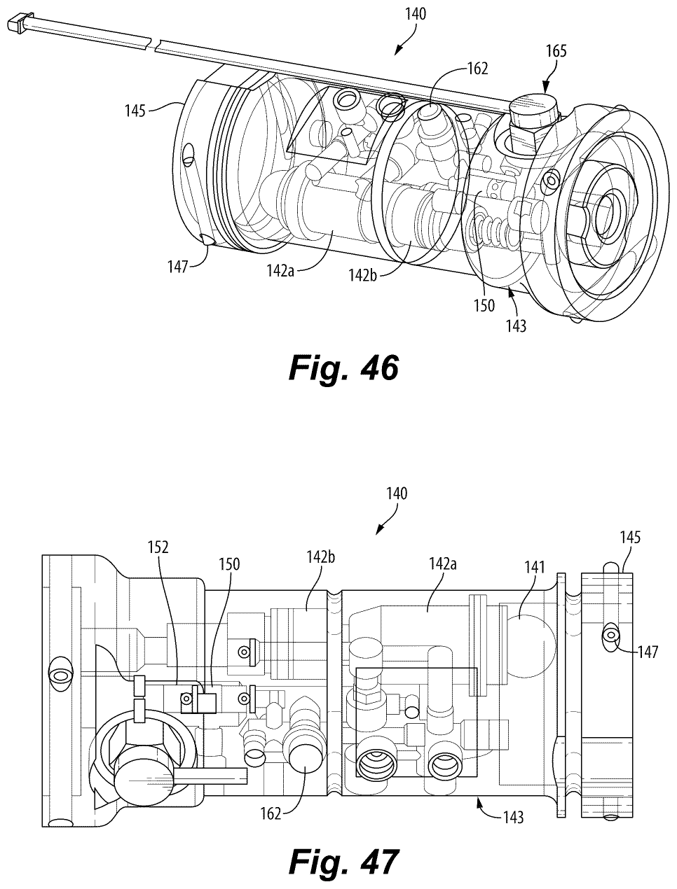

Referring now to FIGS. 27-59, an exemplary embodiment of the power unit 50 is shown. The power unit 50 includes a motor 70, a transmission assembly 80, a fluid reservoir 120 (examples of which are described above with respect to FIGS. 1-26) and a pump assembly 140.

### Motor and Transmission Assembly

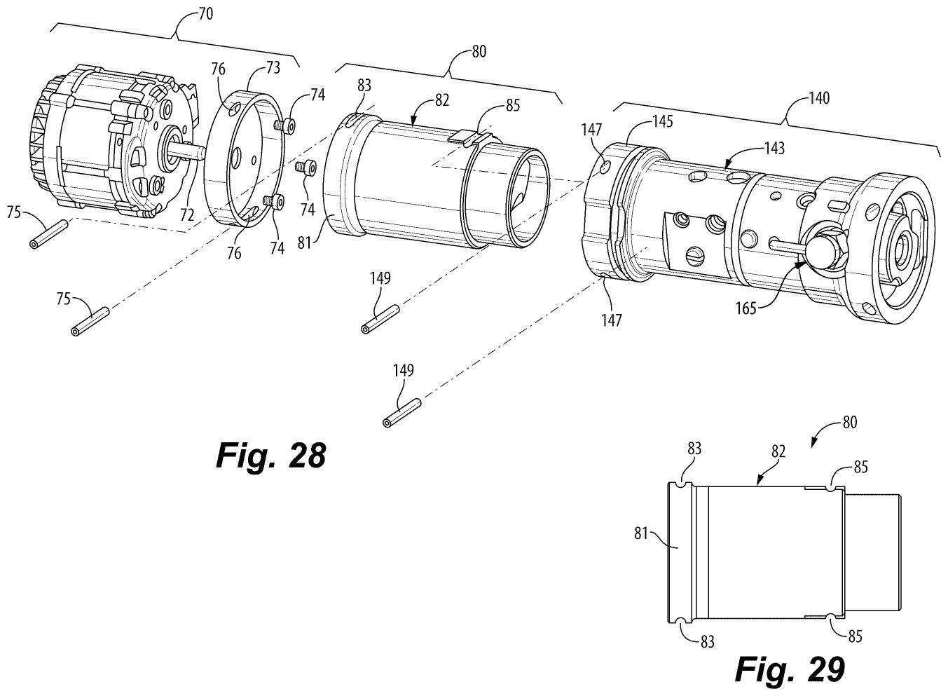

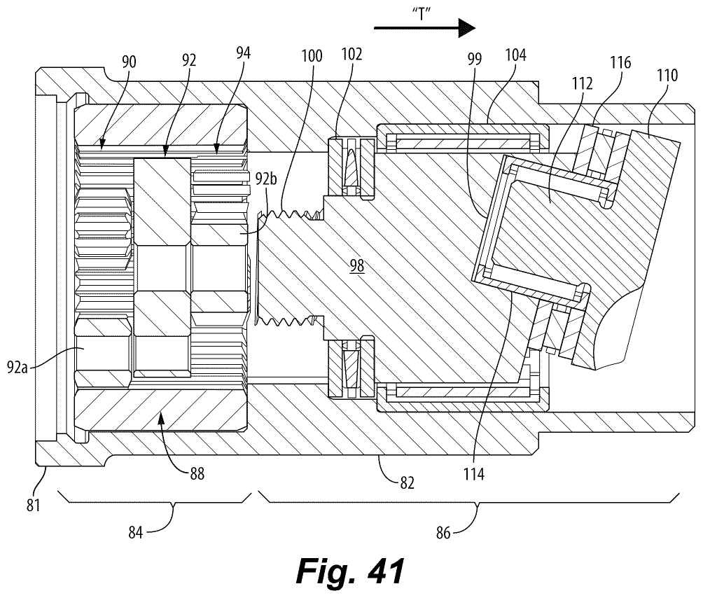

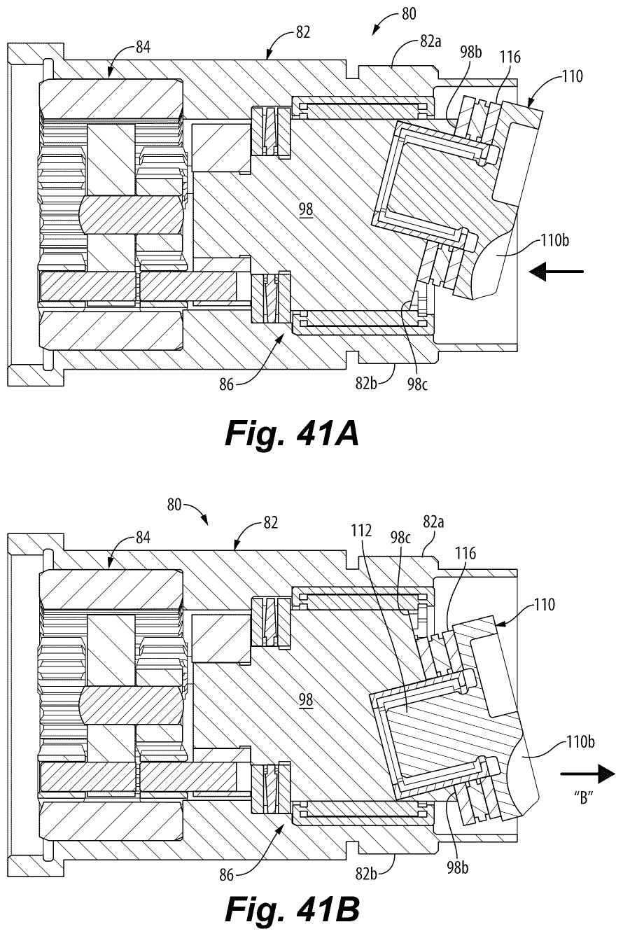

The motor 70, seen in FIGS. 27 and 28, is an electric brushless motor powered by the battery 60 or other power source. In the embodiment shown, the motor 70 is electrically connected to the battery 60 and the actuators 40 and 42, e.g., trigger switches, seen in FIG. 1 and the motor's operation is controlled by the actuators 40 and 42. Generally, the motor 70 is adapted to operate at a nominal voltage corresponding to the voltage of the battery 60, e.g., between about 12 VDC and about 56 VDC. For example, if the battery 60 is adapted to output a voltage of about 24 VDC, then the motor 70 would be adapted to operate at a voltage of about 24 VDC. Under a no-load condition and at 18 VDC, such a motor 70 can operate at about 19,000 rpm with a current of about 3 amps. At maximum efficiency, the motor 70 can operate in a range of about 15,000 rpm to about 18000 rpm with a current at about 17 amps, a torque of about 8.8 in-lb. and an output wattage in a range of about 250 W and about 300 W. However, the motor 70 may be any motor suitable to activate the tool 10. Generally, the motor 70 rotates a motor drive shaft 72 that is coupled to a gear assembly 84, seen in FIG. 41, in the transmission assembly 80, described below.

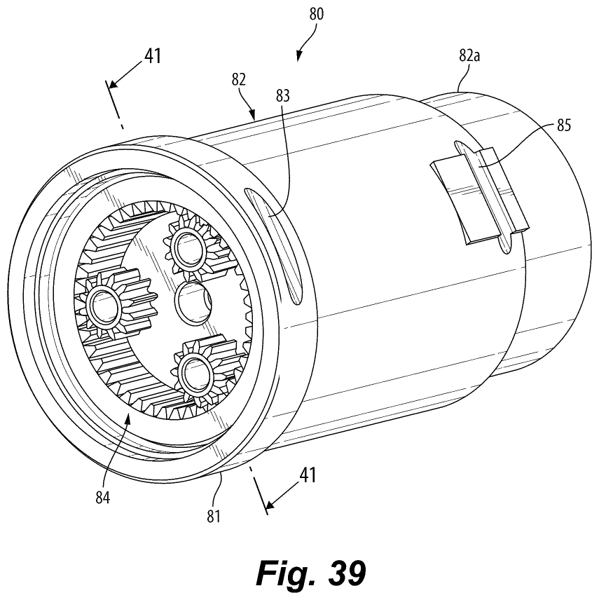

Referring to FIGS. 39-44, an exemplary embodiment of the transmission assembly 80 according to the present disclosure is shown. In this exemplary embodiment, the transmission assembly 80 has a housing 82, and within the housing 82 is a gear assembly 84 and a pump drive assembly 86. The gear assembly 84 in this exemplary embodiment is a multi-stage gear system 88. Each stage in the gear assembly 84 is preferably a planetary gear assembly that includes a pinion gear, two or more planetary gears, a ring gear and a carrier plate. As an example, in the exemplary embodiment shown a first planetary gear assembly 90 is a first stage (or an input stage), a carrier assembly 92 and a second planetary gear assembly 94 is a second stage (or an output stage). The motor drive shaft (not shown) is coupled to the first planetary gear assembly 90. The output of the first planetary gear assembly 90 is coupled to the carrier assembly 92 via pins 92a, and the carrier assembly 92 is coupled to the input of the second planetary gear assembly 94 via a fixed gear 92b of the carrier assembly 92. The output of the second planetary gear assembly 94 is coupled to the pump drive assembly 86. In an exemplary embodiment, the pump drive assembly 86 includes a drive member 98, a first bearing system, wobble plate or disc 110, and a second bearing system. Using this exemplary configuration, the output of the second planetary gear assembly 94 would be coupled to the drive member 98 of the pump drive assembly 86. The output of the second planetary gear assembly 94 rotates the drive member 98 at the output rate of the gear assembly 84. The first bearing system is provided so that the drive member 98 can withstand radial and axial loads generated during an operation of the tool 10, tool 310 or tool 410. In the exemplary embodiment shown, the bearing system includes a thrust bearing 102 and radial bearing 104. The thrust bearing 102 is provided to withstand axial (or thrust) loads on the drive member 98, in the direction of arrow “T” seen in FIG. 41, as the drive member 98 rotates during operation of the tool 10. An example of a suitable thrust bearing 102 is the Koyo Bearing No. NTA613 manufactured by JTEKT North America Corporation. The radial bearing 104 is provided to withstand radial loads on the drive member 98 as it rotates during operation of the tool 10. An example of a suitable radial bearing 104 is the Koyo Bearing No. BK1010 manufactured by JTEKT North America Corporation.

As an example, the motor 70 may be configured to rotate the motor drive shaft (not shown) at a rate in the range of about 15,000 rpm and about 18,000 rpm with an output torque in the range of about 8.8 in-lb. In this configuration, the battery voltage may be in the range of about 12 VDC and about 56 VDC, and the output motor power may be in the range of about 250 watts and about 300 watts. The gear assembly 84 may reduce the rate of rotation of the drive member 98, seen in FIG. 44, and thus reduces the speed of the wobble plate 110 and the speed of the pump 142, seen in FIG. 45, by range of about 10:1 and about 15:1. The output of the gear assembly 84 is transferred to the drive member 98 of pump drive assembly 86. Movement, e.g., rotation, of the shaft 100 is transferred to rotation of the drive member 98. In the exemplary embodiment of the present disclosure, the output of the gear assembly 84 is rotational motion which is transferred to the drive member 98 of the pump drive assembly 86.

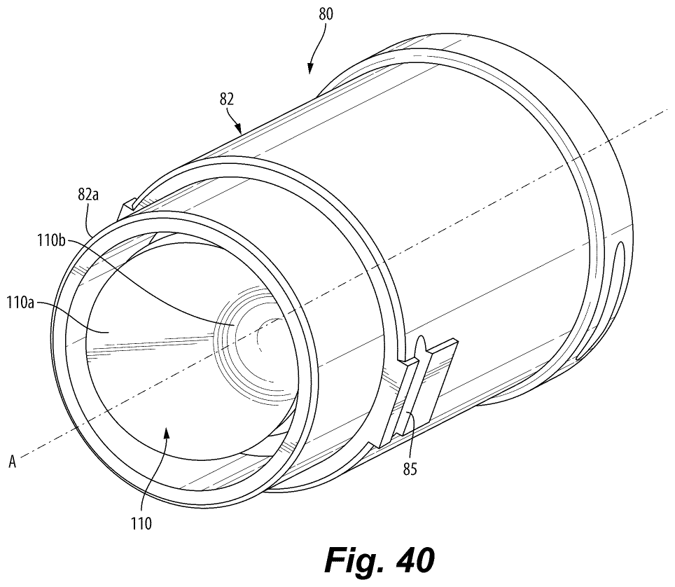

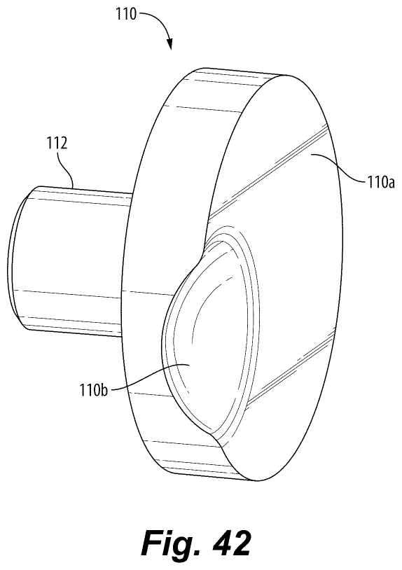

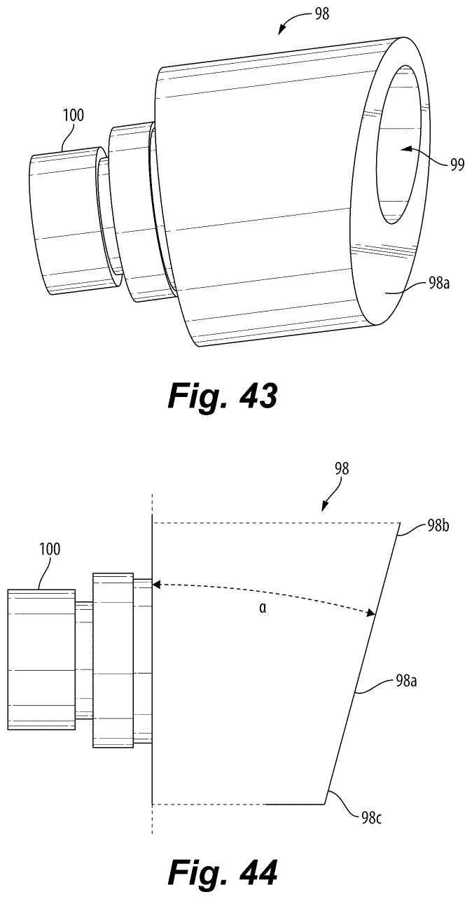

Referring to FIG. 43 and FIG. 44, the face 98a of the drive member 98 is opposite the shaft 100 and is angled to translate rotational movement of the drive member 98 to reciprocal linear movement of the wobble plate or disc 110 of the pump drive assembly 86. Preferably, the angle “a” of the face 98a of the drive member 98 is about 14.5 degrees. However, the angle “a” may be set to other angles. Further, the wobble plate 110 (FIG. 41) is mounted to the drive member 98 at an offset from the center axis “A,” seen in FIG. 40, of the transmission assembly 80. More specifically, the wobble plate 110 includes a mounting arm 112 that is inserted into a needle bearing 114 positioned within a mounting hole 99 in the drive member 98, seen in FIGS. 41-44. The needle bearing 114 is provided to permit the wobbler plate 110 to float freely relative to the drive member 98 and to withstand radial loads on the wobble plate 110 as the drive member 98 rotates during operation of the tool. Between the wobble plate 110 and face 98a of the drive member 98 is a thrust bearing 116. The thrust bearing 116, seen in FIG. 41, is provided to withstand axial (or thrust) loads on the wobble plate 110 in the direction of arrow “T” as the drive member 98 rotates during operation of the tool. The needle bearing 114 and the thrust bearing 116 form the second bearing system of the pump drive assembly 86. An example of a suitable thrust bearing 116 is the Koyo Bearing No. NTA613 manufactured by JTEKT North America Corporation. The face 110a, seen in FIG. 42, of the wobble plate 110 includes a recess 110b in which a ball bearing 141, seen in FIG. 48B, of the pump assembly 140 rests. The recess 110b is offset from the center axis “A” as seen in FIG. 40 of the transmission assembly 80 such that rotation of the drive member 98 is translated to reciprocal linear movement of the wobble plate 110 and thus the ball bearing 141 (FIG. 47) of the pump assembly 140. As an example and referring to FIGS. 41A, 41B, 43 and 44, with a surface 98b of the face 98a of the drive member 98 initially at about a top side 82a of the housing 82, seen in FIG. 41A, the recess 110b in the wobble plate 110 is in a retracted position. When the drive member 98 rotates from this initial position, the surface 98b of the face 98a rotates along with the thrust bearing 116 causing the recess 110b in the wobble plate 110 to move linearly in the direction of arrow “B,” seen in FIG. 41B. When the drive member 98 rotates approximately 180 degrees, the surface 98b of the face 98a is now at about a bottom side 82b of the housing 82, seen in FIG. 41B, causing the recess 110b in the wobble plate 110 to be in a fully extended position. Further rotation of the drive member 98 from the 180 degree fully extended position to the 360 degree position returns the recess 110b in the wobble plate 110 to the retracted position, seen in FIG. 41A. As described in more detail below, the continuous movement of the wobble plate 110 between the retracted position and the fully extended position causes the ball bearing 141 to reciprocate in a liner motion creating a pump movement of about 0.15 inch and about 0.20 inch of total travel.

### Pump Assembly

Referring to FIGS. 45-55, an exemplary embodiment of the pump assembly 140 according to the present disclosure is shown. The pump assembly 140 has a housing 143. The pump assembly 140 includes a pump 142, a low-pressure inlet check valve 146, a low-pressure outlet check valve 148, a high-pressure inlet check valve 150, a high-pressure outlet check valve 152, a low-pressure bypass valve 154, a spool plunger assembly 156 and a drain check valve 158. The pump 142, low-pressure inlet check valve 146, low-pressure outlet check valve 148, high-pressure inlet check valve 150, high-pressure outlet check valve 152, low-pressure bypass valve 154, spool plunger assembly 156 and drain check valve 158 along with other components of the pump assembly 140 are housed in the housing 141. The pump 142 is a two-stage reciprocating hydraulic piston pump. The pump 142 is shown schematically in FIG. 45. Preferably, the pump 142 operates at about 10,000 psi. The pump 142 is a stepped design, combining both a low pressure pump (a first stage) 142a and a high pressure pump (a second stage) 142b into a single component or housing as shown in FIG. 55. The schematic representation of the pump 122, seen in FIG. 45, shows the low pressure pump 142a and the high pressure pump 142b separated for simplicity of interpretation. However, the two pumps 142a and 142b are preferably a single component and move together in a reciprocating motion.

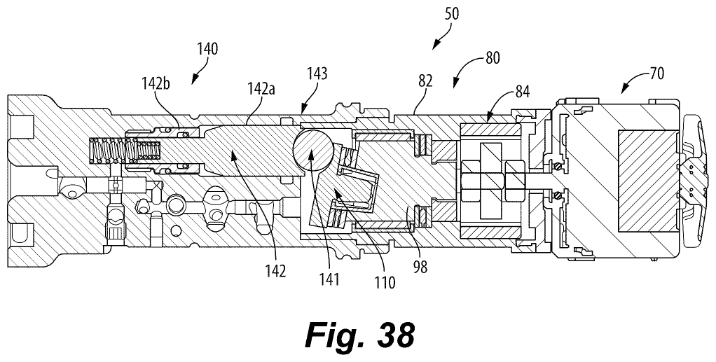

As noted above, continuous movement of the wobbler plate 110 (FIG. 40) between the retracted position and the fully extended position causes the ball bearing 141 (FIG. 38) to activate the pump 142 in a liner, reciprocating fashion. Generally, when the pump 142 reciprocates, hydraulic fluid is pumped (or moved) from the reservoir 120, seen in FIGS. 5, 6, 9, 10, 13-19 and 23-25, to the ram drive fluid conduit 144, shown in the fluid circuit schematic of FIG. 45, to supply hydraulic fluid to the working head piston assembly 230. (FIG. 67) More specifically, on the intake stroke of the pump 142, the low pressure pump first stage 142a draws fluid from the reservoir 120 through the low-pressure inlet check valve 146. On the exhaust stroke of the pump 142, the low-pressure pump 142a pushes hydraulic fluid through the low-pressure outlet check valve 148 into the ram drive fluid conduit 144. In unison with the low-pressure pump first stage 142a, on the intake stroke of the pump 142, the high pressure pump second stage 142b draws hydraulic fluid from the reservoir 120 through the high-pressure inlet check valve 150. On the exhaust stroke of the pump 142, the high pressure pump second stage 142b pushes hydraulic fluid through the high-pressure outlet check valve 152 into the ram drive fluid conduit 144.

During a cycle of the tool 10, e.g., a crimping cycle or a cutting cycle, the piston assembly 230, seen in FIG. 60 and FIG. 61, of the working head 20 initially moves a ram 246 rapidly toward its full operating position, e.g., its crimping or cutting position, as a result of the low and high pressure pumps first stage 142a and second stage 142b moving the maximum amount of hydraulic fluid from the reservoir 120 to the piston assembly 230 via the ram drive fluid conduit 144. However, when the ram 246 encounters a workpiece between jaws or dies of the working head 20, the pressure against the ram 246 quickly increases. With the increase in pressure imposed on the ram 246 by the workpiece, the motor 70 may begin to overload because of the increased pressure on the low-pressure pump 142a, which is the larger diameter pump. To limit or remove the pressure on the low-pressure pump 142a, the low-pressure by-pass valve 154 activates to permit hydraulic fluid to flow back into the reservoir 120. More specifically, the low-pressure by-pass valve 154 is preconfigured to open and close when the pressure on the low-pressure pump 142a reaches a predefined pressure level. Preferably, the predefined pressure level is about 600 psi. When the pressure on the low-pressure pump 142a reaches the predefined pressure level, with each stroke of the pump 142, the low-pressure by-pass valve 154 opens and closes permitting hydraulic fluid to flow back into the reservoir 120. In other words, fluid pressure in excess of the predefined pressure level is diverted back to the reservoir 120 by diverting (or dumping) the hydraulic fluid from the low-pressure pump 142a back into the reservoir 120 instead of pushing the hydraulic fluid from the low-pressure pump 142a to the ram drive fluid conduit 144. As a result, the motor 70 (FIG. 23) drives the high-pressure pump 142b to a preferred pressure value of about 10,000 psi without overloading the motor 70 and the transmission assembly 80 (FIG. 5). When the motor 70 drives the high-pressure pump 142b to the preferred pressure value, the controller 300 may sense the preferred pressure value has been reached using, for example, a pressure sensor 165 operatively coupled to the pump assembly 140 and the controller 300, seen in FIG. 69. When the controller 300 senses that the preferred pressure value has been reached, the controller 300 activates an audio visual indicator signal generator 302, shown in FIG. 69, to provide an audible indication to the operator that the preferred pressure value has been reached so that the operator knows that the operation of the working head has completed. In addition, the controller 300 may activate the indicator signal generator 302, shown in FIG. 69, to provide a visible indication to the operator that the preferred pressure value has been reached so that the operator knows that the operation of the working head has completed.

After the fluid circuit has achieved full pressure, e.g., about 10,000 psi, the tool operating cycle is complete. The piston 254 and thus the ram 246 of the piston assembly 230, seen in FIGS. 60 and 61, of the working head 20 is then returned to its at rest (or home) position by draining the high-pressure fluid in the ram drive fluid conduit 144 (FIG. 45) into the reservoir 120 (FIG. 5 and FIG. 6) in preparation for the next operating cycle of the tool 10. Draining the hydraulic fluid from the ram drive fluid conduit 144 is achieved by activating a spool plunger assembly 156 (FIG. 45). The spool plunger assembly 156 includes a release member 162 and a plunger 164. It is noted that in the embodiment shown, the release member 162 is a mechanically activated release member. In the embodiment shown, the release member 162 is activated by activating the operator control 40. More specifically, and referring to FIGS. 2B, 45 and 54, activating the operator control actuator 40 causes an activating arm of the operator control 40 to depress the release member 162. Other types of release members are also contemplated by the present disclosure, such as an electro-mechanical activated release member or a cable release member. As shown in FIG. 54, the plunger 164 has a tip portion 164a, an end portion 164b and a main body 164c between the tip portion 164a and the end portion 164b. The plunger 164 is positioned within a cavity in a housing of the pump assembly 140 and is operatively coupled to the release member 162 as described below. To activate the spool plunger assembly 156, the operator control 40 is activated causing the activating arm 45 (FIG. 2B) to depress the release member 162. The release member 162 is configured to act on the plunger 164 such that the plunger 164 moves toward the drain check valve 158 to open the drain check valve. More specifically, the release member 162 has a stem 162a with a proximal end 162c that is at least partially accessible from an exterior of the housing of the pump assembly 140. The stem 162a has a tip 162b with an angled surface 162d that is configured to fit within a V-shaped like notch 164d in the main body 164c of the plunger 164. When the release member 162 is actuated, e.g., mechanically depressed, by the activating arm 45 (FIG. 2B), the tip portion 164a of the plunger 164 moves toward the drain check valve 158 and knocks a ball 158a of the drain check valve 158 off its seat. Knocking the ball 158a of the drain check valve 158 off its seat opens the drain check valve 158 allowing fluid in the ram drive fluid conduit 144 to drain back to the reservoir 120 via a drain line 172 (FIG. 45). It is noted that the hydraulic fluid in the ram drive fluid conduit 144 and thus on the drain check valve 158 may be under high pressure, e.g., as much as 10,000 psi. Such high pressure may be acting on the ball 158a of the drain check valve 158. In order for the spool plunger assembly 156 to knock the ball 158a of the drain check valve 158 off its seat, a force as high as, for example, 200 lbs may be needed. This force is a force the release member 162 would have to apply to the plunger 164 in order to open the drain check valve 158. With a mechanical release member 162, the force is manually applied by an operator. Forces as high as 200 lbs. require a fairly large lever so that the operator can activate the spool plunger assembly 156 using a finger. To lower the force that may be needed to open the drain check valve 158 to a reasonable value of for example 15 lbs., a pressure balance system 160 may be used with the spool plunger assembly 156. In the embodiment shown, the pressure balance system 160 (FIG. 45) includes a pilot conduit 166 (FIG. 45 and FIG. 54), a scaling member 168 and a biasing member 170. The pilot conduit 166 is connected between the plunger 164 and the ram drive fluid conduit 144. As a result, the pilot conduit 166 would be under the same pressure, e.g., 10,000 psi, as the ram drive fluid conduit 144. The sealing member 168 is positioned around the end portion 164b of the plunger 164, as shown in FIG. 54, and seals the end portion 164b of the plunger within a housing of the plunger 164 so that hydraulic fluid in the pilot conduit 166 does not pass the end portion 164b of the plunger 164. In the embodiment shown, the sealing member 168 is an O-ring. Hydraulic fluid in the pilot conduit 166 acts on the end portion 164b of the plunger 164 applying a force on the end portion 164b of the plunger 164 in the direction of the drain check valve 158 sufficient to overcome the biasing force of the biasing member 170 so that the tip portion 164a of the plunger 164 applies a force against the ball 158a of the drain check valve 158. The biasing member 170, e.g., a compression spring, is positioned between the drain check valve 158 and the plunger 164 and normally biases the plunger 164 in a direction away from the drain check valve 158. In this configuration, the pressure balance system 160 reduces the high pressure, e.g., the 10,000 psi, applied to drain check valve 158 so that a lower force is needed to activate the spool plunger assembly 156. It is also noted that the biasing member 170 also biases the plunger 164 to its home position between cycles of the tool 10 permitting the ball 158a of the drain check valve 158 to reseat and thus close the drain check valve 158.

Referring again to FIG. 28, an exemplary configuration for coupling the motor 70 to the transmission assembly 80 is shown. In this exemplary embodiment, a collar 73 is attached to the motor 70 using fasteners 74. A collar 81 of the housing 82 of the transmission assembly 80 is then positioned within the collar 73, and pins 75 are inserted into openings 76 in a side wall of the collar 73 through an open area of the collar 73 and through a second opening 76 in the side wall of the collar. When the pins 75 pass through collar 73, the pins 75 pass within grooves 83 in the collar 81 of the transmission assembly housing 82. The portion of the pins 75 resting in the grooves 83 in the collar 81 lock the motor 70 in position relative to the housing 82 in the transmission assembly 80. Continuing to refer to FIG. 28, an exemplary configuration for coupling the motor 70 and the transmission assembly 80 to the pump assembly 140 is shown. In this exemplary embodiment, the housing 143 of the pump assembly 140 has a collar 145 with pin openings 147 in a side wall of the collar 145. Pins 149 are inserted into the openings 147 in the collar 145 into an open area of the collar 145 and through a second opening 147 in the side wall of the collar. When pins 149 pass through the collar 145, the pins 149 pass within grooves 85 in the transmission assembly housing 82. The portion of the pins 149 resting in the grooves 85 in the transmission assembly housing 82 lock the pump assembly housing 143 in position relative to the transmission assembly housing 82.

### Pump Assembly Description

Referring to FIG. 56-59, another exemplary embodiment for coupling the motor 70 and the transmission assembly 80 to the pump assembly 140 is shown. In this exemplary embodiment, the pump assembly housing 143 has a threaded end 151, e.g., a male threaded end, and the transmission assembly housing 82 has a collar 87 with a threaded interior wall, e.g., a female threaded end. However, it is contemplated that the pump assembly housing 143 may have a female threaded end, and the collar 87 may have a male threaded end. In this embodiment, to couple the motor 70 and the transmission assembly 80 to the pump assembly 140, the top side 82a of the transmission assembly housing 82 is positioned into the threaded end 151 of the pump assembly housing 143 so that the coupler 87 of the transmission assembly housing 82 can be threaded onto the threaded end 151 of the pump assembly housing 143, as shown. It is noted that the collar 87 of the transmission assembly housing 82 may be fixed to the transmission assembly housing 82 or may be rotatable relative to the transmission assembly housing 82. If the collar 87 of the transmission assembly housing 82 is fixed to the transmission assembly housing 82, the transmission assembly housing 82 or the pump assembly housing 143 may be rotated to thread the collar 87 onto the threaded end 151. If the collar 87 is rotatable relative to the transmission assembly housing 82, the collar 87 may be rotated to thread the collar 87 onto the threaded end 151.

### Working Head

Referring now to FIGS. 60-68, an exemplary embodiment of a working head 25 of the tool 10 is shown. As noted above, the working head may be any working head that has an operating cycle driven by hydraulic pressure. Non-limiting examples of working heads 25 that have an operating cycle driven by hydraulic pressure include working heads 25 having a crimp operating cycle and working heads having a cutting operating cycle. In the embodiment shown in FIGS. 60-68, the working head 25 is configured for a crimp operating cycle where a movable die in a die set is moved toward a fixed die in the die set.

In this exemplary embodiment, the working head 25 includes a head frame 200 and a piston assembly 230. The head frame 200 has a substantially C-shaped body 202 forming a working area 204. A proximal end of the body 202 has a flange or neck 206 that is used to couple the piston assembly 230 to the head frame 200. A distal end of the body 202 includes a die seat 208 configured to receive and hold a die of a die set used when performing a crimping operation of the tool 10. Within the working area 204 of the head frame 200 is an interior T-shaped track 210 formed into the body 202. The T-shaped track 210 is configured and dimensioned to interact with a T-shaped guide 256 on a ram 246 of a ram assembly 234, described below.

The piston assembly 230 includes a cylindrical body 232 and a ram assembly 234. The cylindrical body 232 has a face end 236 and an open end providing access to a hollow central portion 238 of the cylindrical body 232. The face end 236 of the cylindrical body 232 includes a stem 240 extending away from the face end 236 such that the stem 240 is substantially perpendicular to the face end 236. The stem 240 is preferably integral to the cylindrical body 232 and serves as a connection point to mate with the ram drive fluid conduit 144 of the pump assembly 140 (FIG. 67). The cylindrical body 232 has a bore 244 extending through the stem 240 into the hollow central portion 238. Hydraulic fluid from the pump assembly 140 is pumped through the fluid bore 244 to move a ram 246 of the ram assembly 234 from its initial home position (or at rest position), seen in FIG. 60, to a full operating position, which in this embodiment is a crimping position. The cylindrical body 232 is adapted to fit at least partially within the flange or neck 206 of the body 202 of the head frame 200 and to be releasably secured to the flange 206. The face end 236 of the cylindrical body 232 has a rotation groove 264 that mates with an opposing groove in the housing of the pump assembly 140. Pins 266 (FIG. 67) are passed through openings in the housing of the pump assembly 140 to mate the piston assembly 230 (FIG. 230) to the pump assembly 140 (e.g., see FIG. 67). Once the cylindrical body 232 is mated to the pump assembly housing 143 (FIG. 56), the working head assembly 20 can rotate about the stem 240. This configuration permits an operator to rotate the working head assembly 25 relative to the handle assembly 30 (FIGS. 1A and 1B). In addition, the face end 236 of the cylindrical body 232 may include a dust seal 268 (FIG. 64) provided to limit and possibly prevent contaminants from entering the rotation groove 264 and stem 240. Adjacent to the dust seal 268 is a guide surface 232a (FIG. 61) of the cylindrical body 232 that provides stability for the working head assembly 25 relative to a face of the pump assembly 140.

The ram assembly 234 is positioned at least partially within the hollow central portion 238 of the cylindrical body 232 and is sealed within the hollow central portion 238 of the cylindrical body 232 using a wiper ring 233 and a “T” seal 235. The wiper ring 233 is scaled between the flange 206 of the body 202 and the cylindrical body 232, as shown in FIGS. 38, 40, 42 and 43. The ram assembly 234 includes a ram 246, a spring holder 248 and two or more nested springs 250. The nested springs 250 are preferably compression type springs. The nested springs 250 provide sufficient force to ensure the ram 246 quickly retracts from the crimping position to the home position so as to reduce the crimp cycle time.

The ram 246 has a die seat 252 at one end and a hollow piston 254 adjacent the die seat 252, as shown in FIG. 61. The die seat 252 includes a T-shaped guide 256 that is configured and dimensioned to operatively interact with the T-shaped track 210 in the working area 204 of the head frame 200. More specifically, the T-shaped guide 256 has two legs 258, seen in FIG. 61A. Each leg 258 has a track guide arm 260 that extends toward the opposite leg such that the legs 258 and track guide arms 260 form a T-shaped channel 262 for receiving the T-shaped track 210. The spring holder 248 and the two or more nested springs 250 are positioned with in the hollow piston 254 of the ram 246 with spring holder 248 positioned in the center of the two or more nested springs 250 and a retainer 251 supporting the two or more nested springs 250, as seen in FIGS. 61 and 63. A non-limiting example of a retainer 251 is a clip and washer assembly. It is noted that in this configuration, with the spring holder 248 and the retainer 251, the overall length of the assembly is greatly reduced, thus reducing the overall weight of the tool 10. One end of the spring holder 248 is positioned within the opening 244 in the cylindrical body 232 such that when hydraulic fluid is pumped into the opening 244 in the stem 240, the ram 246 moves along the T-shaped track 210 from the at home (or rest) position to the crimping position.

Referring now to FIG. 69, the motor 70, the transmission assembly 80, the fluid reservoir 120, the pump assembly 140, a controller 300 are shown in block form and as described above are located within the tool frame 32 (FIG. 1A and FIG. 1B) of the handle assembly 30. It is noted that the tool 10 may also include a camera 42, seen in block form in FIG. 69, mounted to the exterior of the tool frame 32 and oriented to provide a video of a working area of the working head assembly 20. The battery 60 is removably connected to one end of the hand grip portion 38 of the tool frame 32. In another embodiment, the battery 60 could be removably mounted or connected to any suitable position on the tool frame 32. In another embodiment, the battery 60 may be affixed to the tool 10 so that it is not removable. The battery 60 is preferably a rechargeable battery, such as a lithium-ion battery, that can output a voltage of at least 12 VDC, and preferably in the range of between about 12 VDC and about 56 VDC.

Continuing to refer to FIG. 69, the motor 70 is coupled to the battery 60 and the controller 300, and its operation is controlled by the controller 300. Generally, the motor 70 is adapted to operate at a nominal voltage corresponding to the voltage of the battery 60, e.g., between about 12 VDC and about 24 VDC. Under a no-load condition, such a motor 70 can operate at about 21,000 rpm with a current of about 2.7 amps. At maximum efficiency, the motor 70 can operate at about 15,000 rpm with a current of about 12 amps, a torque of about 75 mN-m, and an output of about 165 W. An example of such an 18 VDC motor 70 is the RS-550VC-7030 motor, manufactured by Mabuchi Motor Co., Ltd. of Chiba-ken, Japan. However, as noted above, any suitable type of motor adapted to operate at or above a 12 VDC nominal voltage could be used. As another example, the motor may be a motor adapted to operate at a 24 VDC nominal voltage. The output shaft of the motor 70 is connected to the transmission assembly 80 which is connected to the pump assembly 140 as described above. While the transmission assembly 80 is described using a multi-stage planetary gear assembly, any suitable type of gear reduction assembly could be used with the transmission assembly 80.

In another exemplary embodiment, the controller 300 may be adapted to sense a current drop of electricity to the motor 70. When the pressure relief valve 146 (FIG. 45) opens, resistance to rotation of the motor 30 is reduced such that the motor draws less current. The controller 300 senses this current drop via a current sensor (not shown) and automatically deactivates the motor 30 for a predetermined period of time. In one embodiment, the predetermined period of time is between about 2 seconds and about 3 seconds. However, any suitable predetermined period of time could be set. In another embodiment, the controller 34 could be adapted to deactivate the motor 70 until a reset button or reset like procedure is performed by the operator. With this type of system, an operator can sense via tactile feedback that the motor 70 and pump assembly 140 (FIG. 54) have stopped and would not need to rely on an audible signal being heard or a visual signal from audio visual indicator 302 (FIG. 69) positioned on the tool 10.

The foregoing embodiments and advantages are merely exemplary and are not to be construed as limiting the scope of the present invention. The description of an exemplary embodiment of the present invention is intended to be illustrative, and not to limit the scope of the present invention. Various modification, alternatives and variations will be apparent to those of ordinary skill in the art and are intended to fall within the scope of the invention.

What is claimed is:

1. A hydraulic power tool with adjustable center of gravity, the hydraulic power tool comprising:
a handle assembly having a frame, the handle assembly capable of being operatively coupled to one of a plurality of differently configured working head assemblies; and
a power unit housed by the frame;
wherein the power unit is longitudinally movable and positionable within the frame depending on which of the plurality of differently configured working head assemblies is operatively coupled to the handle assembly to maintain a substantially constant center of gravity of the hydraulic power tool regardless of which of the plurality of differently configured working head assemblies is operatively coupled to the handle assembly.

2. The hydraulic power tool according to claim 1, the power unit comprising;
a motor;
a transmission assembly; and
a pump assembly.

3. The hydraulic power tool according to claim 2, further comprising a fluid reservoir in fluid communication with the pump assembly.

4. The hydraulic power tool according to claim 3, wherein the fluid reservoir is affixed to the power unit and comprises a hollow tubular body encompassing at least a portion of the power unit by 360 degrees.

5. The hydraulic power tool according to claim 4, wherein the fluid reservoir is movable and positionable within a main body portion of the frame when the power unit is moved and positioned within the frame, the main body portion of the frame comprising at least one detent for limiting movement of the fluid reservoir within the main body portion of the frame when the power unit is moved and positioned within the frame.

6. The hydraulic power tool according to claim 3, wherein the fluid reservoir in fluid communication with the pump assembly comprises one of a plurality of fluid reservoirs that may be removably attached to the pump assembly, the plurality of fluid reservoirs comprising a first fluid reservoir comprising a hollow tubular body encompassing at least a portion of the power unit by 180 degrees, a second fluid reservoir comprising a hollow tubular body encompassing at least a portion of the power unit by 120 degrees, and a third fluid reservoir comprising a hollow tubular body encompassing at least a portion of the power unit by 90 degrees.

7. The hydraulic power tool according to claim 6, wherein each of the plurality of fluid reservoirs corresponds to at least one of the plurality of differently configured working head assemblies and is dimensioned to maintain a substantially constant center of gravity of the hydraulic power tool when the corresponding working head assembly is operatively coupled to the handle assembly.

8. The hydraulic power tool according to claim 7, wherein each of the plurality of fluid reservoirs comprises a self-sealing valve stem.

9. The hydraulic power tool according to claim 6, wherein the plurality of fluid reservoirs are the same length and/or thickness.

10. The hydraulic power tool according to claim 6, wherein the plurality of fluid reservoirs are different lengths and/or thicknesses.

11. The hydraulic power tool according to claim 2, wherein each of the plurality of differently configured working head assemblies comprises a head frame and a piston assembly, the piston assembly being rotatably coupled to the pump assembly such that the piston assembly is in fluid communication with an output conduit of the pump assembly.

12. The hydraulic power tool according to claim 2, wherein the transmission assembly is in series with and operatively coupled to the motor.

13. The hydraulic power tool according to claim 9, wherein the pump assembly is in series with and operatively coupled to the transmission assembly

14. The hydraulic power tool according to claim 2, wherein the transmission assembly comprises a gear assembly and a pump drive assembly.

15. A hand-held power tool with adjustable center of gravity, the handle-held power tool comprising:
a handle assembly capable of being operatively coupled to one of a plurality of differently configured working head assemblies;
a power unit housed by the handle assembly; and
wherein the power unit is movable and positionable within the handle assembly depending on which of the plurality of differently configured working head assemblies is operatively coupled to the handle assembly to maintain a substantially constant center of gravity of the hand-held power tool regardless of which of the plurality of differently configured working head assemblies is operatively coupled to the handle assembly.

16. The hand-held power tool according to claim 15, wherein each of the differently configured working head assemblies comprises a flange dimensioned to be received in a distal end of the handle assembly.

17. The hand-held power tool according to claim 15, further comprising a plurality of differently configured end caps for removably covering a proximal end of the handle assembly.

18. The hand-held power tool according to claim 15, wherein the hand-held power tool comprises a hydraulic power tool and wherein the power unit further comprises a fluid reservoir.

19. The hand-held power tool according to claim 18, wherein the fluid reservoir is affixed to the power unit and comprises a hollow tubular body encompassing at least a portion of the power unit by 360 degrees.

20. The hand-held power tool according to claim 18, wherein the fluid reservoir further comprises a plurality of removable and replaceable differently configured fluid reservoirs.
